(19) United States
(12) Patent Application Publication
(10) Pub. No.: US 2018/0186902 A1
(43) Pub. Date: Jul. 5, 2018

(54) CATALYSTS

(71) Applicant: Qatar Foundation, Doha (QA)

(72) Inventors: John A. Gladysz, College Station, TX (US); Hassan Said Bazzi, Doha (QA); Zhenxing Xi, Sugar Land, TX (US)

(21) Appl. No.: 15/736,095

(22) PCT Filed: Aug. 14, 2015
(86) PCT No.: PCT/GB2015/052352

§ 371 Date: Dec. 13, 2017

(30) Foreign Application Priority Data
Aug. 11, 2015 (GB) 1514188.0
Aug. 13, 2015 (GB) 1514410.8

(51) Int. Cl. C08F 4/80; C08F 110/02

(52) U.S. Cl. CPC C08F 4/80; C08F 2500/09; C08F 2500/03; C08F 110/02

(57) ABSTRACT

The present invention relates to polymerisation catalysts.

### DESCRIPTION OF INVENTION

The present invention relates to catalysts. In particular, the present invention relates to catalysts for use in polymerisation. The present invention also relates to a process for the production of polymers, for example polyethylene.

### BACKGROUND

Polyethylene is one of the most commonly used plastic materials for packaging, which is evidenced by its annual production of approximately 80 million tonnes.

Nickel catalysts have received much attention in polymerisation reactions because they allow the introduction of numerous polar comonomers, leading to heretofore inaccessible classes of polymers. However, the ability of nickel catalysts to tolerate polar comonomers comes with a relatively low rate of polymerisation.

Over the last 15 years, the development of single component square planar nickel(II) catalysts for the polymerisation of ethylene has received intense attention.¹⁻⁵ One impetus has been the compatibility of such late transition metal catalysts, which are distinguished by their moderated electrophilicity, with polar monomers that contain carboxylic acid or alcohol derivatives, and the ability to attain heretofore inaccessible copolymers. As depicted in Scheme 1, many of these incorporate salicylaldiminato ligands (1,2 or IV,V),^{1,2c,4,5b} although other types of C—O/C═NAr or C═O/C—NAr chelates have been employed.^{2a,b,5a,c} The ligating C—O moieties in 1,2 feature bulky ortho substituents to inhibit the formation of bis(salicylaldiminato) complexes. The N-aryl groups contain two bulky ortho substituents, the purpose of which is to sterically shield sites axial to the nickel coordination plane, thereby inhibiting the rate of chain transfer relative to propagation. These properties have allowed a variety of microstructures to be engineered into high molecular weight polymers.

High turnover frequencies are more challenging to achieve with neutral single component polyethylene catalysts as opposed to multicomponent systems where an activator aids the abstraction of a ligand. The latter are exemplified by MAO (methylaluminoxane) and early transition metal halides, which deliver highly electrophilic cationic species, as well as many earlier generation nickel catalysts.^{1a} Both the activator and the resulting highly electrophilic cationic species are incompatible with polar comonomers, i.e. monomers that have functional groups. The present inventors have sought to develop a protocol termed “phase transfer catalyst activation”, whereby a ligand in a catalyst precursor that must dissociate to generate the active catalyst is phase labeled, such that it rapidly transfers to a second phase orthogonal to the catalyst and reactants.⁶⁻⁸ Rate accelerations can be expected when the initial dissociation is reversible, and the substrate and ligand compete for the active catalyst (k₋₁[L]≥k₂[substrate]), as depicted with intermediate I in Scheme 1. When the former term dominates in the full rate expression (Scheme 1), the limit B obtains, and anything that diminishes the ligand concentration ([L]) will increase the reaction velocity. Furthermore, in the case of polymerisations, the ligand can potentially inhibit every propagation cycle (e.g., addition of L as opposed to ethylene to III in Scheme 1).

Studies with catalyst 2 and related species have established that under the usual ethylene pressures, the readdition of the dissociated ligand PPh₃ to the intermediate I is faster than the subsequent binding of ethylene.^{1a} The present inventors' phase transfer activation methodology has so far been applied to fluorous/organic and aqueous/organic liquid/liquid biphasic systems, as well as liquid/solid biphasic systems,⁶⁻⁸ but has not yet been applied beyond olefin metathesis with ruthenium catalysts.

In summary, nickel salicylaldiminato complexes, and related C—O/C═NAr or C═O/C—NAr chelates, catalyze ethylene polymerisation. Previous reports of the use of nickel salicylaldiminato complexes relate to polymerisation under monophase conditions in organic solvents such as toluene. Rates were generally slow, requiring much fine tuning.

It would, therefore, be preferable increase the rates of polymerisation.

### SUMMARY

The present invention is as set out in the following clauses:

1. A polymerisation catalyst having the structure:

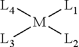

wherein:
M is Ni or Pd,
L₁ is alkyl or aryl,
L₂ and L₃ together form a bidentate ligand, and
L₄ is a fluorous phosphorous donor ligand, a fluorous nitrogen donor ligand, a fluorous sulfur donor ligand or a fluorous oxygen donor ligand.

2. The polymerisation catalyst of clause 1, wherein M is Ni.

3. The polymerisation catalyst of clause 1 or clause 2, wherein the fluorous phosphorous donor ligand, fluorous nitrogen donor ligand, fluorous sulfur donor ligand or fluorous oxygen donor ligand (L₄) includes at least one fluorine atom attached to an aliphatic moiety; optionally at least, 2, 3, 4, 5, 6, 7, 8, 9, 10, 11, 12, 13, 14, 15, 16, 17, 18, 19, 20 or more fluorine atoms attached to an aliphatic moiety.

4. The polymerisation catalyst of any one of the previous clauses, wherein L₄ is a fluorous phosphorous donor ligand selected from the group consisting of a fluorinated phosphine ligand (generally, PRₓR_{y}R_{z}), a fluorinated phosphite ligand (generally, PORₓOR_{y}OR_{z}), fluorinated PRₓOR_{y}OR_{z}, fluorinated PRₓR_{y}OR_{z}; wherein Rₓ, R_{y} and R_{z} are the same or different; or fluorinated phosphapyridine.

5. The polymerisation catalyst of any one of the previous clauses, wherein L₄ is a fluorous phosphorous donor ligand having the structure:

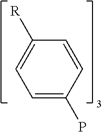

wherein R is (CH₂)ₙ(CF₂)ₘCF₃, or (CH₂)ₙ(CHF)ₘCF₃, and,
n is 0, 1, 2, 3, 4, 5, 6, 7, 8, 9 or 10, and,
m is 0, 1, 2, 3, 4, 5, 6, 7, 8, 9 or 10; or,

wherein L₄ is a fluorous phosphorous donor ligand having the structure:

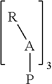

wherein R is (CH₂)ₙ(CF₂)ₘCF₃, or (CH₂)ₙ(CHF)ₘCF₃, and,
n is 0, 1, 2, 3, 4, 5, 6, 7, 8, 9 or 10,
m is 0, 1, 2, 3, 4, 5, 6, 7, 8, 9 or 10; and,
A is aliphatic.

6. The polymerisation catalyst of any one of the previous clauses, wherein L₄ is a fluorous phosphorous donor ligand having the structure:

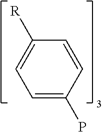

wherein R is (CH₂)₂(CF₂)₇CF₃ or (CH₂)₃(CF₂)₇CF₃.

7. The polymerisation catalyst of any one of clauses 1 to 3, wherein L₄ is: a fluorous nitrogen donor ligand selected from the group consisting of a fluorinated amine ligand, a fluorinated nitrile ligand, a fluorinated pyridine ligand, fluorinated heterocycles with a basic lone pair of electrons, fluorinated imines, fluorinated Schiff bases; or,

a fluorous oxygen donor ligand selected from the group consisting of a fluorinated ether.

8. The polymerisation catalyst of any one of the previous clauses, wherein L₁ is alkyl and is selected from the group consisting of straight-chain or branched-chain hydrocarbon having 1, 2, 3, 4, 5, 6, 7, 8, 9, 10, 11, 12, 13, 14, 15, 16, 17, 18, 19 or 20 carbon atoms linked exclusively by single bonds and not having any cyclic structure.

9. The polymerisation catalyst of clause 8, wherein L₁ is alkyl and is selected from the group consisting of methyl, ethyl, n-propyl, isopropyl, n-butyl, isobutyl, sec-butyl, tert-butyl, pentyl, iso-amyl, hexyl, heptyl, octyl, noyl, decyl, undecyl, dodecyl tridecyl, tetradecyl, pentadecyl, hexadecyl, heptadecyl, octadecyl, nonadecyl and eicosyl.

10. The polymerisation catalyst of any one of the previous clauses wherein L₁ is methyl (CH₃).

11. The polymerisation catalyst of any one of the previous clauses, wherein L₁ is aryl and is selected from the group consisting of a substituted or unsubstituted aromatic hydrocarbon with a conjugated cyclic molecular ring structure of 3, 4, 5, 6, 7, 8, 9, 10, 11 or 12 carbon atoms.

12. The polymerisation catalyst of clause 11, wherein L₁ is aryl and is selected from the group consisting of monocyclic, bicyclic or polycyclic.

13. The polymerisation catalyst of clause 12, wherein L₁ includes one to three additional ring structures selected from the group consisting of a cycloalkyl, a cycloalkenyl, a heterocycloalkyl, a heterocycloalkenyl, or a heteroaryl.

14. The polymerisation catalyst of clause 12 or clause 13, wherein L₁ is selected from the list consisting of phenyl (benzenyl), thiophenyl, indolyl, naphthyl, totyl, xylyl, anthracenyl, phenanthryl, azulenyl, biphenyl, naphthalenyl, 1-methylnaphthalenyl, acenaphthenyl, acenaphthylenyl, anthracenyl, fluorenyl, phenalenyl, phenanthrenyl, benzo[a]anthracenyl, benzo[c]phenanthrenyl, chrysenyl, fluoranthenyl, pyrenyl, tetracenyl (naphthacenyl), triphenylenyl, anthanthrenyl, benzopyrenyl, benzo[a]pyrenyl, benzo[e]fluoranthenyl, benzo[ghi]perylenyl, benzo[j]fluoranthenyl, benzo[k]fluoranthenyl, corannulenyl, coronenyl, dicoronylenyl, helicenyl, heptacenyl, hexacenyl, ovalenyl, pentacenyl, picenyl, perylenyl, and tetraphenylenyl.

15. The polymerisation catalyst of any one of clauses 12 to 14 wherein substituted aryl refers to aryls substituted with 1, 2, 3, 4 or 5 substituents selected from the group consisting of H, lower alkyl, aryl, alkenyl, alkynyl, arylalkyl, alkoxy, aryloxy, arylalkoxy, alkoxyalkylaryl, alkylamino, arylamino, NH₂, OH, CN, NO₂, OCF₃, CF₃, Br, Cl, F, 1-amidino, 2-amidino, alkylcarbonyl, morpholino, piperidinyl, dioxanyl, pyranyl, heteroaryl, furanyl, thiophenyl, tetrazolo, thiazole, isothiazolo, imidazolo, thiadiazole, thiadiazole S-oxide, thiadiazole S,S-dioxide, pyrazolo, oxazole, isoxazole, pyridinyl, pyrimidinyl, quinoline, isoquinoline, SR′″, SOR′″, SO₂R′″, CO₂R′″, COR′″, CONR′″R′″, CSNR′″R′″ and SOnNR′″R′″, where n is zero, one or two, wherein R′″ is alkyl or substituted alkyl.

16. The polymerisation catalyst according to any one of the previous clauses, wherein L₂ and L₃ together form a bidentate ligand, the bidentate ligand selected from the group consisting of, salicylaldiminato, oxalate, ethylenediamine, 2,2′-bipyridine, 1,10-phenanthroline, acetylacetonate and phenanthroline. Optionally, L₂ and L₃ together may form one or more of the ligands set out in references 1-5 (inclusive), the subject matter of which references are incorporated herewith by reference.

17. The polymerisation catalyst according to any one of the previous clauses, wherein L₂ and L₃ together form a bidentate ligand having the structure:

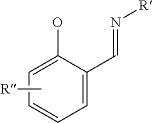

wherein:
R′ is H,

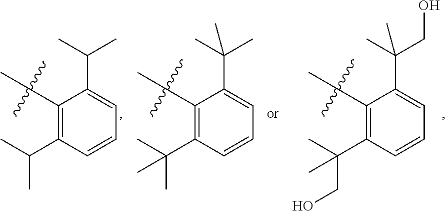

and

R″ is OCH₃, NO₂ or

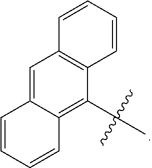 [SMILES: *c1c2ccccc2cc2ccccc12]

Optionally, L₂ and L₃ together form a bidentate ligand as set out in any one of cited reference 1-5 (inclusive), the subject matter of which is incorporated herewith by reference

18. The polymerisation catalyst according to any one of the previous clauses, wherein L₂ and L₃ together form a bidentate ligand, the bidentate ligand being a salicylaldiminato ligand.

19. The polymerisation catalyst according to any one of the previous clauses, wherein L₂ and L₃ together form a bidentate ligand having the structure:

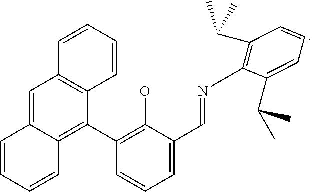

20. The polymerisation catalyst according to any one of the previous clauses, wherein the polymerisation catalyst has the structure:

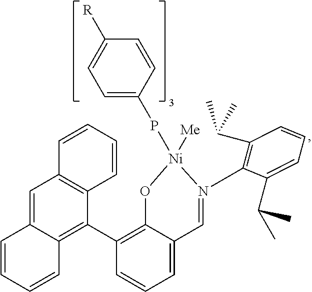

wherein R is (CH₂)₂(CF₂)₇CF₃.

21. The polymerisation catalyst according to any one of clauses 1 to 19, wherein the polymerisation catalyst has the structure:

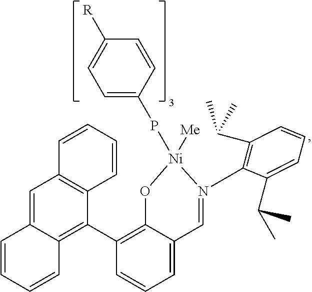

wherein R is (CH₂)₃(CF₂)₇CF₃.

22. A biphasic mixture comprising:
a first solvent and a second solvent, wherein the first solvent and second solvent are immiscible, and
a polymerisation catalyst which dissolves in the first solvent, the polymerisation catalyst including a ligand which reversibly disassociates from the polymerisation catalyst and transfers into the second solvent. Optionally, 25% to 99% by weight of the ligand which reversibly disassociates from the polymerisation catalyst transfers into the second solvent. Further optionally, 33% to 99% by weight, 33% to 66% by weight or 65% to 99% by weight of the ligand which reversibly disassociates from the polymerisation catalyst transfers into the second solvent.

23. The biphasic mixture of clause 22, further comprising monomers which dissolve in the first solvent.

24. The biphasic mixture of clause 23, wherein the monomers compete with the ligand for the active catalyst formed when the ligand disassociates from the active catalyst.

25. The biphasic mixture of any one of clauses 22 to 24, wherein:
the first solvent is an organic solvent and the second solvent is a fluorous solvent.

26. The biphasic mixture of clause 25, wherein the first solvent is an organic solvent selected from the group consisting of: toluene, benzene, aromatic solvents, ethers, diethyl ether, dichloromethane, chloroform, ethyl acetate or acetone. Optionally, the organic solvent may be any of the solvents as set out in references 1-5 (inclusive) the subject matter of which are incorporated herewith by reference.

27. The biphasic mixture of any one of clauses 25 or 26, wherein the second solvent is a fluorous solvent selected from the group consisting of: perfluoro(methylcyclohexane) (PFMC), perfluoro(2-butyltetrahydrofuran) (FC-75), a fluorocarbon, wherein a fluorocarbon is a hydrocarbon in which all carbon atoms are bonded to fluorine atoms, a fluorohydrocarbon, wherein a fluorohydrocarbon is a hydrocarbon in which one or more carbon atoms is bonded to a fluorine atom. Optionally, the fluorous solvent may be any of the solvents as set out in U.S. Pat. No. 5,463,082, the subject matter of which is incorporated herewith by reference.

28. The biphasic mixture of any one of clauses 22 to 27, wherein the polymerisation catalyst is as set out in any one of clauses 1 to 21.

29. The biphasic mixture of any one of clauses 22 to 27, wherein the polymerisation catalyst includes a ligand which reversibly disassociates from the polymerisation catalyst and transfers into the second solvent, the ligand having the structure of any ligand as set out in any one of clauses 1 to 21. Optionally, 25% to 99% by weight of the ligand which reversibly disassociates from the polymerisation catalyst transfers into the second solvent. Further optionally, 33% to 99% by weight, 33% to 66% by weight or 65% to 99% by weight of the ligand which reversibly disassociates from the polymerisation catalyst transfers into the second solvent.

30. The biphasic mixture of any one of clauses 22 to 29, wherein:
the first solvent is toluene,
the second solvent is PFMC or FC-75,
the polymerisation catalyst has the structure:

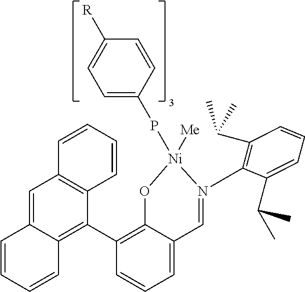

wherein R is (CH₂)₂(CF₂)₇CF₃ or (CH₂)₃(CF₂)₇CF₃,
and the ligand which reversibly disassociates from the polymerisation catalyst and transfers into the second solvent has the structure,

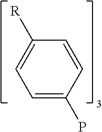

wherein R is (CH₂)₂(CF₂)₇CF₃ or (CH₂)₃(CF₂)₇CF₃, respectively.

31. The biphasic mixture of any one of clauses 23 to 30, wherein the monomer is ethylene. Alternatively the monomer or monomers may be as required to form the polymers set out in reference 3b, the subject matter of which is incorporated herewith by reference.

32. The biphasic mixture of any one of clauses 22 to 24, wherein the first solvent is an organic solvent and the second solvent is water. Optionally, in this biphasic mixture the ligand which reversibly disassociates from the polymerisation catalyst and transfers into the second solvent is a water soluble ligand, for example a phosphine ligand.

33. The biphasic mixture of any one of clauses 22 to 24, wherein the first solvent is an organic solvent and the second solvent is a solid phase. Optionally, the ligand which reversibly disassociates from the polymerisation catalyst and transfers into the second solvent is a fluorous donor ligand; fluorous donor ligands include the ligands described as such in patent publication number US 2006/0094866 A1 (the subject matter of which is incorporated herewith by reference).

34. The biphasic mixture of clause 33, wherein the solid phase is a fluorous solid phase. Optionally, wherein the fluorous solid phase is as set out in US patent publication number US 2006/0094866 A1 (the subject matter of which is incorporated herewith by reference) or in U.S. Pat. No. 7,875,752 B1 (the subject matter of which is incorporated herewith by reference).

35. The biphasic mixture of clause 33 or clause 34, wherein the solid phase is any one of:
(a) Teflon® shavings (Teflon is a registered trademark of DuPont for polytetrafluoroethylene) and other polytetrafluoroethylene shavings;
(b) high-surface area forms of Teflon® and other forms of polytetrafluoroethylene; optionally Teflon® that has been deliberately damaged, etched, or modified by chemical or mechanical means;
(c) non-commercial grades or analogs of Teflon®, which may be in-situ generated, of lower molecular weight, contain structural defects, impurities, or co-monomers that may disrupt the regular structure;
(d) all other perfluorinated or highly fluorinated polymers;
(e) non-fluorous polymers (polyamides, polyolefins, polyesters, etc.) or biomaterials into which fluorous domains have been incorporated, for example by copolymerization, functionalization, grafting, or other techniques;
(f) inorganic oxides such as alumina or silica onto which fluorous domains have been introduced, for example by absorption or covalent attachment; optionally, fluorous silica gel or FluoroFlash™ silica gel, commercially available from Fluorous Technologies Inc. (Pittsburgh, Pa.);
(g) all other solid polymeric or extended domain materials including binary phases, tertiary phases, single crystals, supramolecular compounds, etc. onto which fluorous domains have been introduced, for example by absorption or covalent attachment; and
(h) analogous non-polymeric materials or oligomers or mixtures thereof that are insoluble under the low temperature limit workup conditions and contain fluorous domains.

36. The biphasic mixture of any one of clauses 33 to 35 wherein the solid phase is any one of: CF₃(CF₂)₁₀CF₃ (mp 76° C.), CF₃(CF₂)₁₂CF₃ (mp 103° C.), CF₃(CF₂)₁₄CF₃ (mp 125° C.), CF₃(CF₂)₁₈CF₃ (mp 162-169° C.), CF₃(CF₂)₈CF₂H (mp 32° C.) or (F₃C)₃CC(CF₃)₃ (mp 39° C.).

37. The biphasic mixture of any one of clauses 32 to 36, wherein the organic solvent selected from the group consisting of: toluene, benzene, aromatic solvents, ethers, diethyl ether, dichloromethane, chloroform, ethyl acetate or acetone. Optionally, the organic solvent may be any of the solvents as set out in references 1-5 (inclusive) the subject matter of which are incorporated herewith by reference.

38. The biphasic mixture of any one of clauses 32 to 37, wherein the polymerisation catalyst is as set out in any one of clauses 1 to 21.

39. The biphasic mixture of any one of clauses 32 to 37, wherein the polymerisation catalyst includes a ligand which reversibly disassociates from the polymerisation catalyst and transfers into the second solvent, the ligand having the structure of any ligand as set out in any one of clauses 1 to 21. Optionally, 25% to 99% by weight of the ligand which reversibly disassociates from the polymerisation catalyst transfers into the second solvent. Further optionally, 33% to 99% by weight, 33% to 66% by weight or 65% to 99% by weight of the ligand which reversibly disassociates from the polymerisation catalyst transfers into the second solvent.

40. The biphasic mixture of any one of clauses 32 to 39, wherein the monomer is ethylene. Alternatively the monomer or monomers may be as required to form the polymers set out in reference 3b, the subject matter of which is incorporated herewith by reference.

41. A method of forming a polymer, the method comprising the steps of:
dissolving a polymerisation catalyst according to any one of clauses 1 to 21 in a solvent, and
contacting the dissolved polymerisation catalyst with monomers.

42. A method of forming a polymer, the method comprising the steps of:
providing a biphasic mixture according to any one of clauses 22 to 40, and
contacting the dissolved polymerisation catalyst with monomers.

43. The method of clause 41 or 42, further comprising the step of:
contacting the monomers with the dissolved polymerisation catalyst at a pressure above atmospheric pressure; optionally between 6 and 10 atmospheres; optionally at 8 atmospheres plus or minus 10%.

44. The method of any one of clauses 41 to 43, wherein the monomers comprise or consist of ethylene. Alternatively the monomer or monomers may be as required to form the polymers set out in reference 3b, the subject matter of which is incorporated herewith by reference.

### BRIEF DESCRIPTION OF THE DRAWINGS

Embodiments of the invention are described below with reference to the accompanying drawings, in which:

FIG. 1 shows rates of ethylene polymerisation (RT, 8 atm constant pressure). A (left), using 4a: ♦ toluene (10.0 mL); ▪ toluene/PFMC (10.0 mL/5.0 mL); ▴ toluene/FC-75 (10.0 mL/5.0 mL). B (right) using 4b: ♦ toluene (10.0 mL); ▪ toluene/PFMC (10.0 mL/5.0 mL).

FIG. 2 shows rates of ethylene polymerisation (RT, 8 atm constant pressure). A (left) using 4c: ♦ toluene (10.0 mL); ▪ toluene/PFMC (10.0 mL/5.0 mL). B (right) ● 2, toluene (10.0 mL); ♦ 4a, toluene (10.0 mL, repeat from FIG. 1A); ▪ 4a, toluene/PFMC (10.0 mL/5.0 mL, repeat from FIG. 1A).

FIG. 3 shows an overview of the polymerisation apparatus illustrated during reaction B in FIG. 1A (top, 0 min; middle, 30 min; bottom, 60 min).

FIG. 4 shows rates of ethylene polymerisation (RT, 4 atm constant pressure) using 4a: ♦ toluene (10.0 mL); ▪ toluene/PFMC (10.0 mL/5.0 mL).

FIGS. 5 through to 27 inclusive shows NMR data for different compounds described herein, as specified on each figure.

### DETAILED DESCRIPTION

The following explanations of terms and methods are provided to better describe the present compounds and methods, and to guide those of ordinary skill in the art in the practice of the present disclosure. It is also to be understood that the terminology used in the disclosure is for the purpose of describing particular embodiments and examples only and is not intended to be limiting.

“Optional” or “optionally” means that the subsequently described event or circumstance can but need not occur, and that the description includes instances where said event or circumstance occurs and instances where it does not.

“Alkyl” refers to straight-chain or branched-chain hydrocarbons having 1, 2, 3, 4, 5, 6, 7, 8, 9, 10, 11, 12, 13, 14, 15, 16, 17, 18, 19 or 20 carbon atoms linked exclusively by single bonds and not having any cyclic structure. Optionally, alkyl includes methyl, ethyl, n-propyl, isopropyl, n-butyl, isobutyl, sec-butyl, tert-butyl, pentyl, iso-amyl, hexyl, heptyl, octyl, noyl, decyl, undecyl, dodecyl tridecyl, tetradecyl, pentadecyl, hexadecyl, heptadecyl, octadecyl, nonadecyl and eicosyl.

“Aliphatic” includes alkyl, alkenyl, alkynyl, halogenated alkyl and cycloalkyl groups.

“Aryl” refers to substituted or unsubstituted aromatic hydrocarbons with a conjugated cyclic molecular ring structure of 3, 4, 5, 6, 7, 8, 9, 10, 11 or 12 carbon atoms. Optionally, aryl includes monocyclic, bicyclic or polycyclic rings. Optionally, aryl includes one to three additional ring structures selected from the group consisting of a cycloalkyl, a cycloalkenyl, a heterocycloalkyl, a heterocycloalkenyl, or a heteroaryl. Optionally, aryl includes phenyl (benzenyl), thiophenyl, indolyl, naphthyl, totyl, xylyl, anthracenyl, phenanthryl, azulenyl, biphenyl, naphthalenyl, 1-methylnaphthalenyl, acenaphthenyl, acenaphthylenyl, anthracenyl, fluorenyl, phenalenyl, phenanthrenyl, benzo[a]anthracenyl, benzo[c]phenanthrenyl, chrysenyl, fluoranthenyl, pyrenyl, tetracenyl (naphthacenyl), triphenylenyl, anthanthrenyl, benzopyrenyl, benzo[a]pyrenyl, benzo[e]fluoranthenyl, benzo[ghi]perylenyl, benzo[j]fluoranthenyl, benzo[k]fluoranthenyl, corannulenyl, coronenyl, dicoronylenyl, helicenyl, heptacenyl, hexacenyl, ovalenyl, pentacenyl, picenyl, perylenyl, and tetraphenylenyl. Optionally, aryl refers to aryls substituted with 1, 2, 3, 4 or 5 substituents selected from the group consisting of H, lower alkyl, aryl, alkenyl, alkynyl, arylalkyl, alkoxy, aryloxy, arylalkoxy, alkoxyalkylaryl, alkylamino, arylamino, NH₂, OH, CN, NO₂, OCF₃, CF₃, Br, Cl, F, 1-amidino, 2-amidino, alkylcarbonyl, morpholino, piperidinyl, dioxanyl, pyranyl, heteroaryl, furanyl, thiophenyl, tetrazolo, thiazole, isothiazolo, imidazolo, thiadiazole, thiadiazole S-oxide, thiadiazole S,S-dioxide, pyrazolo, oxazole, isoxazole, pyridinyl, pyrimidinyl, quinoline, isoquinoline, SR′″, SOR′″, SO₂R′″, CO₂R′″, COR′″, CONR′″R′″, CSNR′″R′″ and SOnNR′″R′″, wherein R′″ is alkyl or substituted alkyl.

“Bidentate ligand” refers to Lewis bases that donate two electron pairs to a metal atom in an organometallic compound.

“Fluorous phosphorous donor ligand” refers to ligands where phosphorous donates an electron pair to a metal atom in an organometallic compound, where the ligand includes at least one fluorine atom attached to an aliphatic moiety (optionally, an alkyl moiety).

“Fluorinated phosphine ligand” refers to a phosphine ligands (general formula PRₓR_{y}R_{z}; where Rₓ, R_{y} and R_{z} can be the same or different and can each be substituted or unsubstituted alkyl or aryl), where phosphorous donates an electron pair to a metal atom in an organometallic compound, where the ligand includes at least one fluorine atom attached to an aliphatic moiety (optionally, an alkyl moiety).

“Fluorinated phosphite ligands” refers to a phosphite ligands (general formula PORₓOR_{y}OR_{z}; where Rₓ, R_{y} and R_{z} can be the same or different and can each be substituted or unsubstituted alkyl or aryl), where phosphorous donates an electron pair to a metal atom in an organometallic compound, where the ligand includes at least one fluorine atom attached to an aliphatic moiety (optionally, an alkyl moiety).

“Fluorinated PRₓOR_{y}OR_{z}”, “fluorinated PRₓR_{y}OR_{z}” and “fluorinated phosphapyridine” refers to the respective ligands where phosphorous donates an electron pair to a metal atom in an organometallic compound, where the ligand includes at least one fluorine atom attached to an aliphatic moiety (optionally, an alkyl moiety).

“Fluorous nitrogen donor ligand” refers to ligands where nitrogen donates an electron pair to a metal atom in an organometallic compound, where the ligand includes at least one fluorine atom attached to an aliphatic moiety (optionally, an alkyl moiety).

“Fluorinated amine ligand” refers to an amine ligand (general formula NRₓR_{y}R_{z}; where Rₓ, R_{y} and R_{z} can be the same or different and can each be substituted or unsubstituted alkyl or aryl), where nitrogen donates an electron pair to a metal atom in an organometallic compound, where the ligand includes at least one fluorine atom attached to an aliphatic moiety (optionally, an alkyl moiety).

“Fluorinated nitrile ligand” refers to a nitrile ligand (general formula RₓCN; where Rₓ is substituted or unsubstituted alkyl or aryl), where nitrogen donates an electron pair to a metal atom in an organometallic compound, where the ligand includes at least one fluorine atom attached to an aliphatic moiety (optionally, an alkyl moiety).

“Fluorinated pyridine ligand” refers to a pyridine ligand (general formula

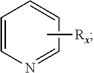

where Rₓ is substituted or unsubstituted alkyl or aryl), where nitrogen donates an electron pair to a metal atom in an organometallic compound, where the ligand includes at least one fluorine atom attached to an aliphatic moiety (optionally, an alkyl moiety).

“Fluorinated heterocycles with a basic lone pair of electrons” refers to a cyclic compound that has atoms of at least two different elements as members of its rings, for example nitrogen, where at least one of the elements in its rings donates an electron pair to a metal atom in an organometallic compound, where the ligand includes at least one fluorine atom attached to an aliphatic moiety (optionally, an alkyl moiety).

“Fluorous sulfur donor ligand” refers to ligands where sulfur donates an electron pair to a metal atom in an organometallic compound, where the ligand includes at least one fluorine atom attached to an aliphatic moiety (optionally, an alkyl moiety).

“Fluorous oxygen donor ligand” refers to ligands where oxygen donates an electron pair to a metal atom in an organometallic compound, where the ligand includes at least one oxygen atom attached to an aliphatic moiety (optionally, an alkyl moiety).

“Fluorocarbon” refers to a hydrocarbon in which all carbon atoms are bonded to fluorine atoms, i.e. all hydrogen atoms are replaced by fluorine.

“Fluorohydrocarbon” refers to a hydrocarbon in which one or more carbon atoms is bonded to a fluorine atom. Optionally, from 20% to 99%, or 30% to 80%, or 40% to 70% of the carbon atoms are bonded to a fluorine atom.

“Monomer” or “monomers” refers to a molecule or molecules that may bind chemically to other molecules to form a polymer.

Fluorous/organic liquid/liquid or solid/liquid biphasic systems have been extensively applied in catalysis over the last twenty years,⁹ and one consequence is the ready synthetic and/or commercial availability of fluorous phosphines. Thus, the present inventors sought variants of 1 or 2 (above) that would remain lipophilic, such that the catalyst precursor would not significantly leach into a fluorous phase, but contained a fluorophilic ligand, for example a fluorophilic triarylphosphine. As shown in Scheme 2, 1 was treated with P(4-C₆H₄R)₃ (3),¹⁰ in which the fluorous para substituents (R=a, (CH₂)₂R_{f8}); b, (CH₂)₃R_{f8}); R_{f8}=(CF₂)₇CF₃) differ in the number of insulating methylene “spacers”. For control purposes, the parent non-fluorous phosphine PPh₃ (3c), was also employed.

Workups gave the expected nickel(II) complexes 4a-c (Scheme 2) as orange powders in 46-68% yields. These were soluble in most common organic solvents and characterized by NMR as described in the supporting information (SI) (below), with reference to the appropriate figures. Partition coefficients were measured by NMR using mixtures of perfluoro(methylcyclohexane) (PFMC) and toluene, and showed 4a,b to be highly lipophilic (concentration ratios <0.5:>99.5; see SI). The analogous partition coefficient of the phosphine 3a was found to be 97.5:2.5;¹¹ that of 3b, 66.6:33.4, had been reported previously.^{10a} Earlier studies have bound the perfluorohexanes/pentane partition coefficient of PPh₃ as <0.5:>99.5.¹² The shorter methylene spacer in 3a should—besides enhancing fluorophilicity—render it a better leaving group and poorer nucleophile than 3b (faster k₁ and slower k₋₁ in Scheme 1).

Polymerisations were conducted at room temperature under 100 psig of ethylene (8 atm) as detailed in the SI. In all cases, ca. 10 mg of catalyst and 10.0 mL of toluene were employed, together in some cases with 5.0 mL of a fluorous solvent. Rates were assayed by the ethylene uptake needed to maintain constant pressure, and the TOF values expressed as grams of polyethylene (adsorbed ethylene) per mol of catalyst per hour. After 60 min, workups gave polyethylene as a white solid, which was characterized as summarized in Table 1.

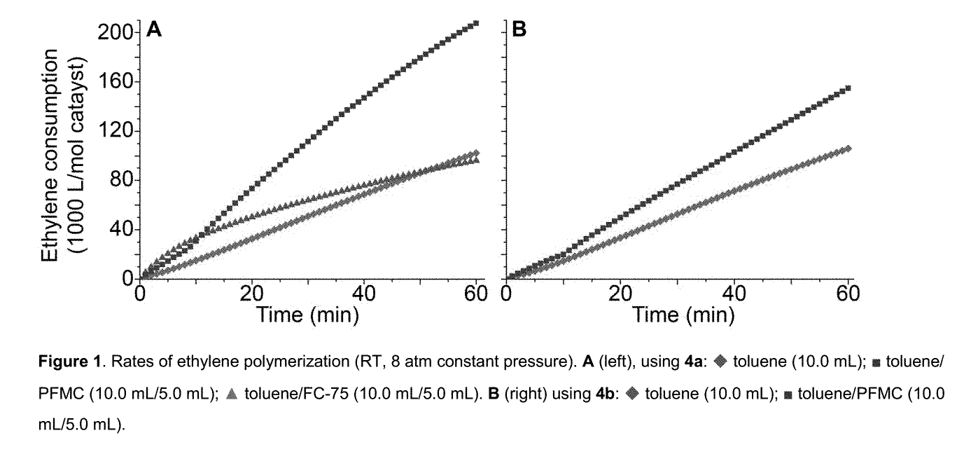

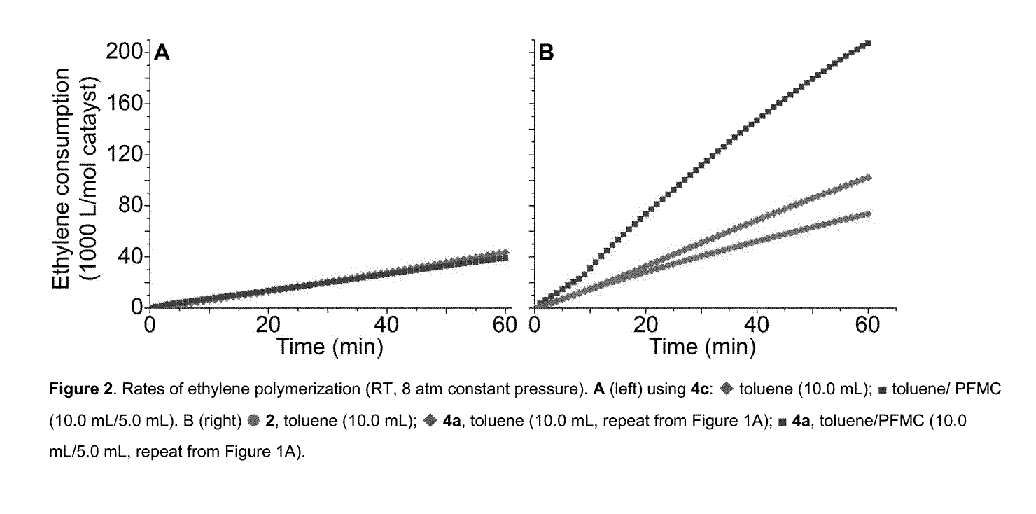

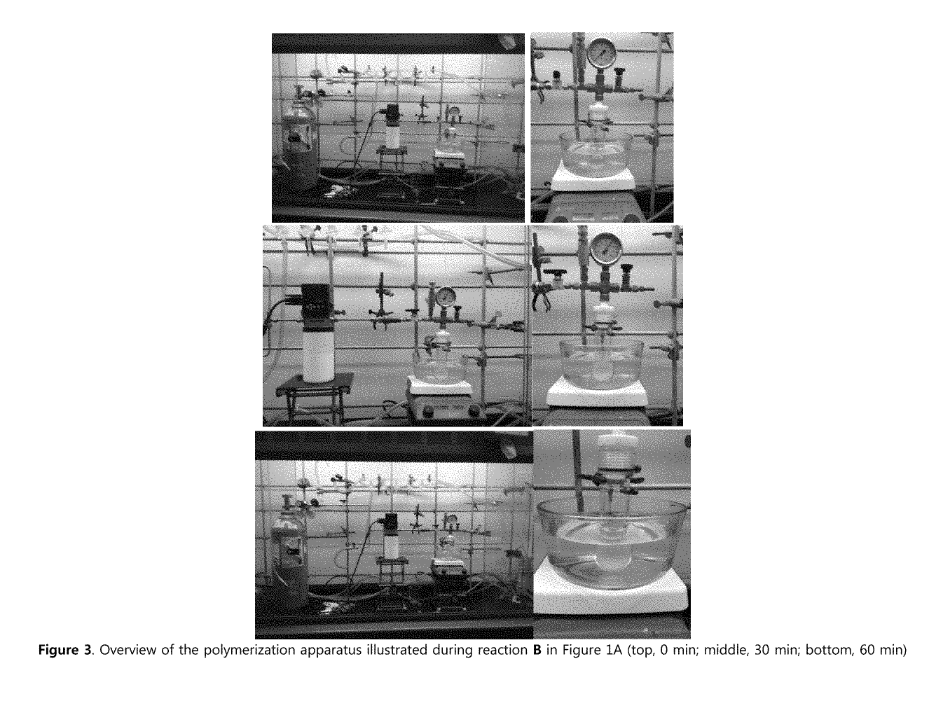

FIG. 1A compares the rate profiles for polymerisations catalyzed by 4a in toluene (10.0 mL, ♦) and a toluene/PFMC biphasic mixture (10.0/5.0 mL, ▪). As can be seen, the biphasic polymerisation was distinctly faster. Since fluorous solvents commonly exhibit higher solubilities than organic solvents for nonpolar diatomic gasses such as O₂, H₂, and N₂,¹³ it was of interest to check for any unanticipated effects with ethylene as a possible factor in the rate trend. However, the solubility of ethylene proved greater in toluene than PFMC (30 vs. 20 g/L under 8 atm), as assayed by a standard procedure (see SI).

Next, analogous monophasic and biphasic polymerisations were conducted using the catalyst with the less fluorous phosphine ligand, 4b. As shown in FIG. 1B, a distinct rate acceleration was again obvious (♦ vs. ▪), but less dramatic than with 4a in FIG. 1A. This is consistent with the lower fluorophilicity and less biased partition coefficient of the phosphine 3b vs. 3a. It is furthermore in accord with the higher nucleophilicity noted above, which would decrease the k₂/k₋₁ ratio.

Returning to FIG. 1A, a second biphasic polymerisation was carried out, but using perfluoro(2-butyltetrahydrofuran) (FC-75) as the fluorous solvent (1). The rate was again accelerated versus the monophasic experiment, but to a lesser extent, and this diminished with time. In other catalytic reactions, FC-75 has given faster rates than PFMC.^{6a,b}

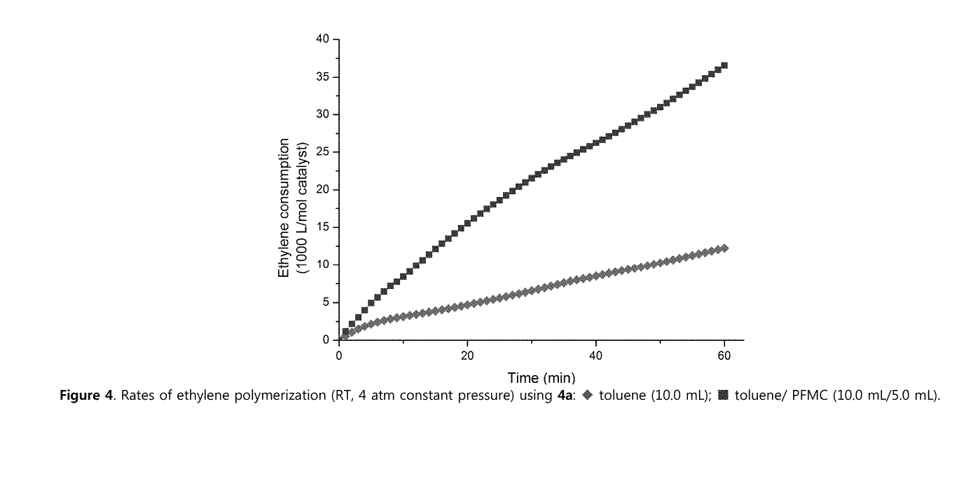

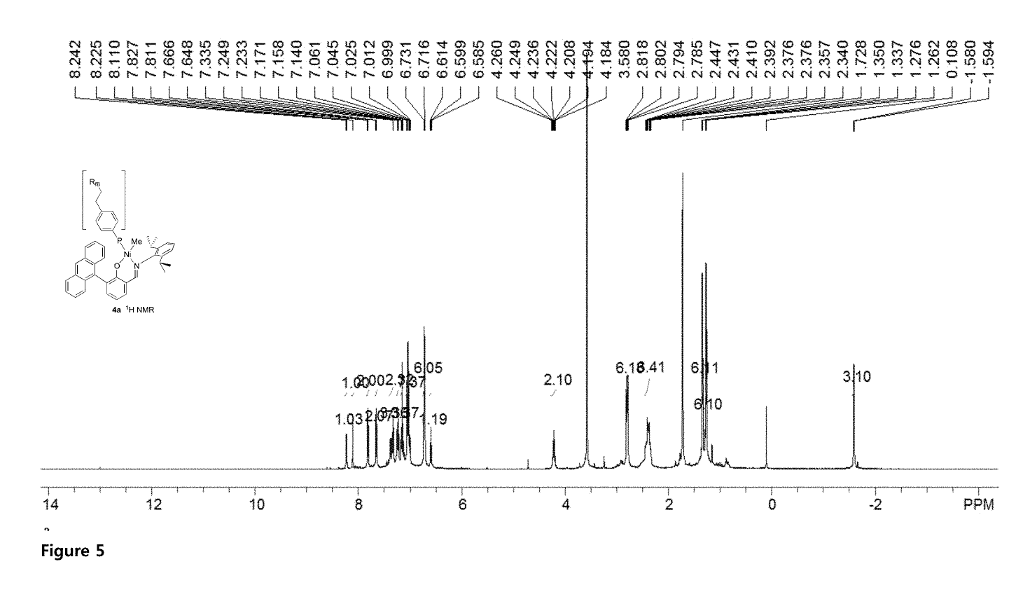

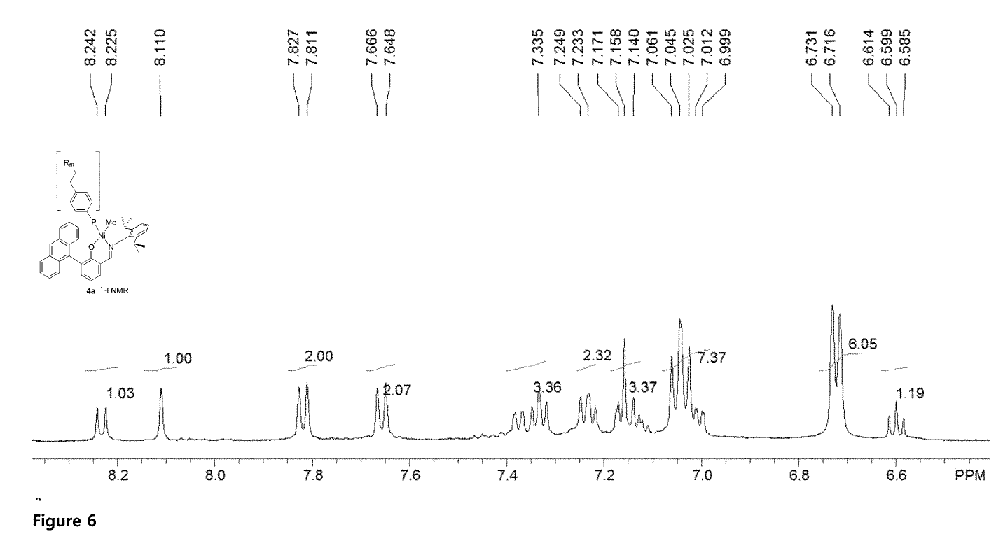

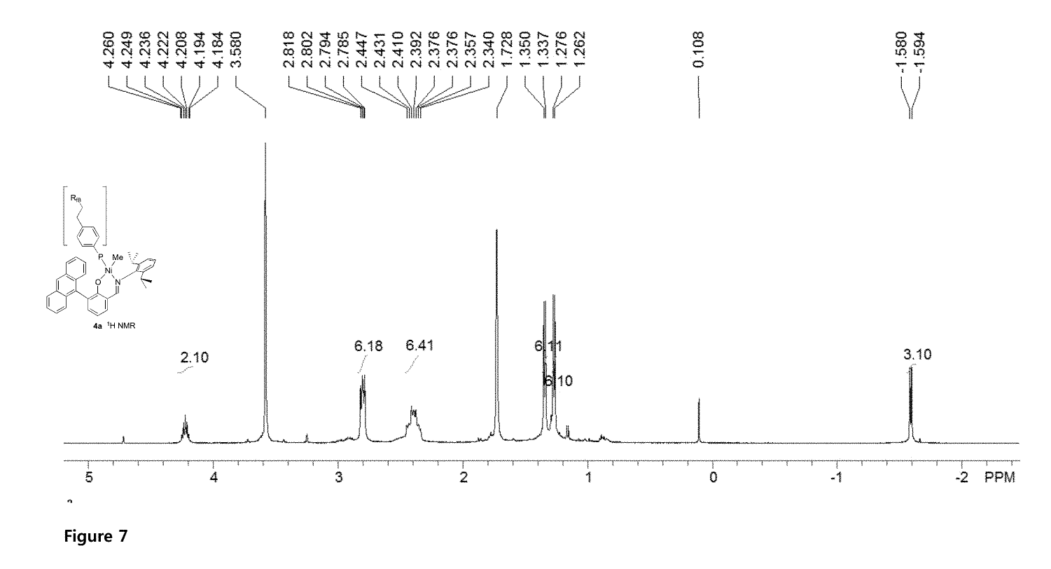

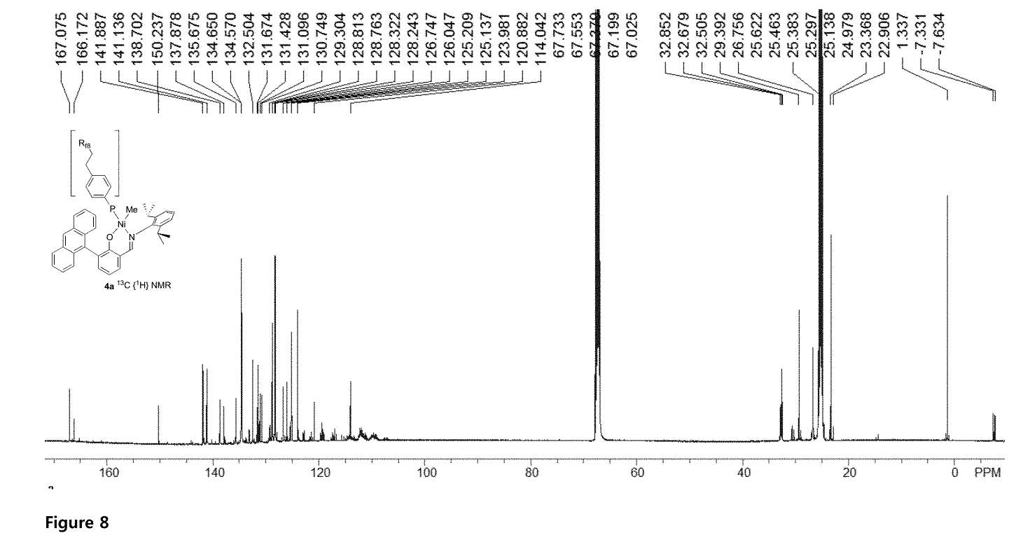

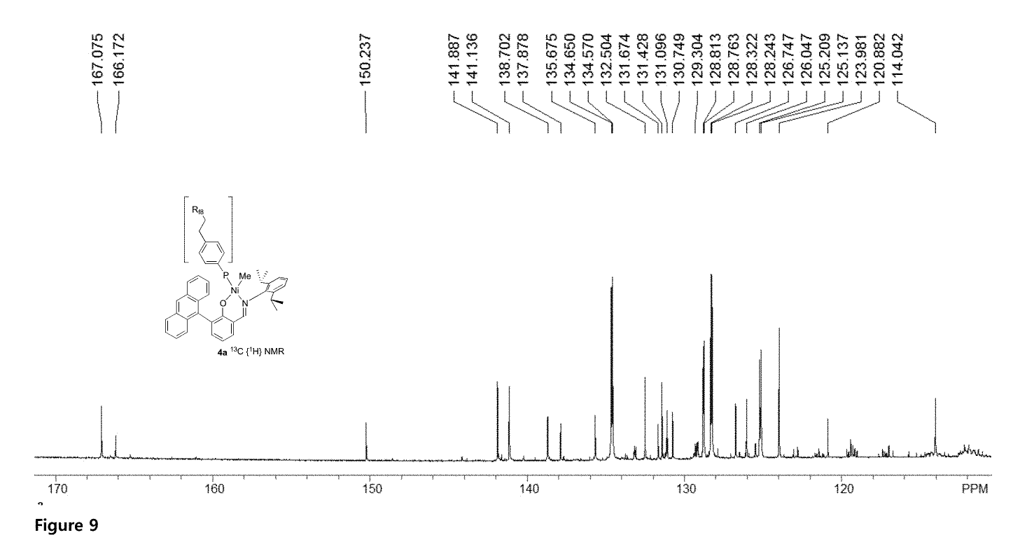

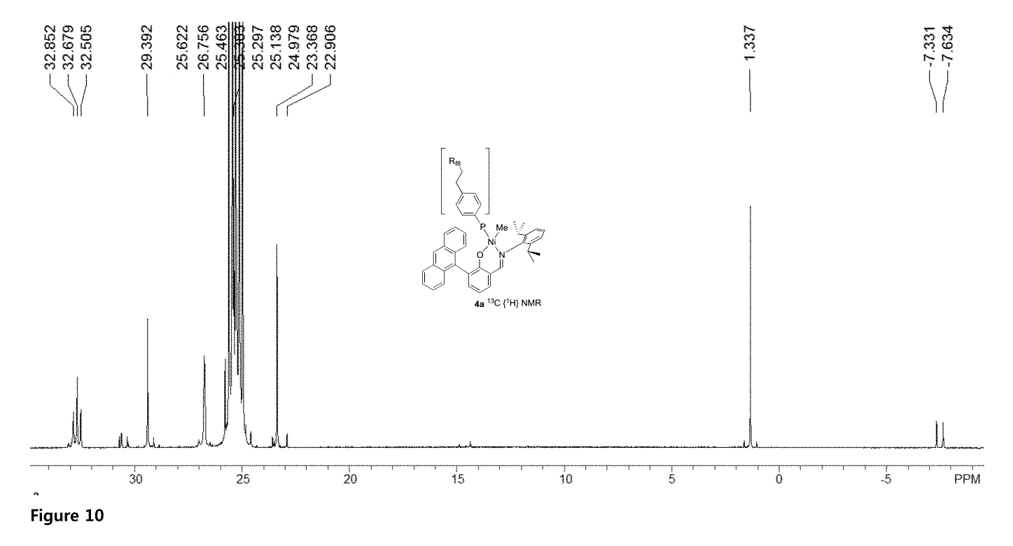

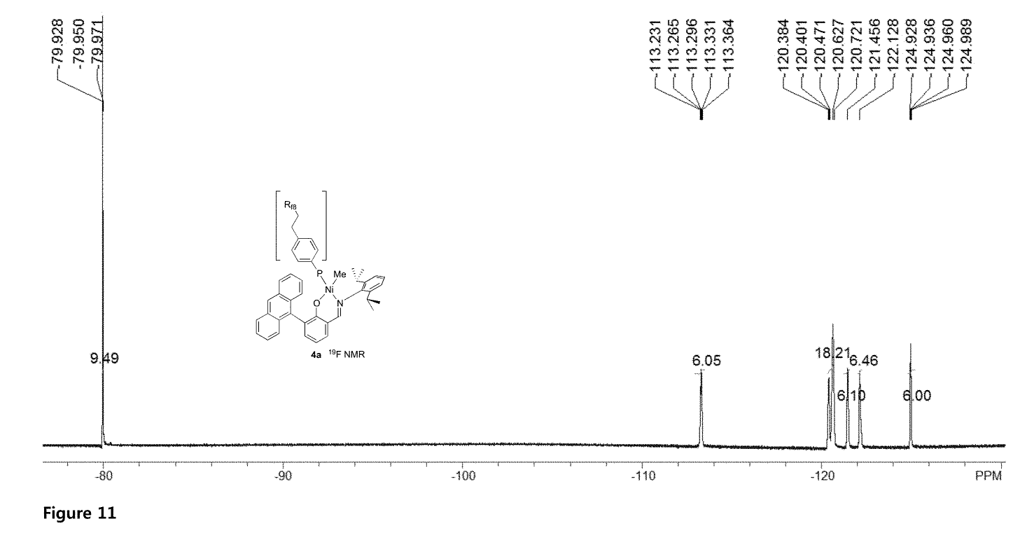

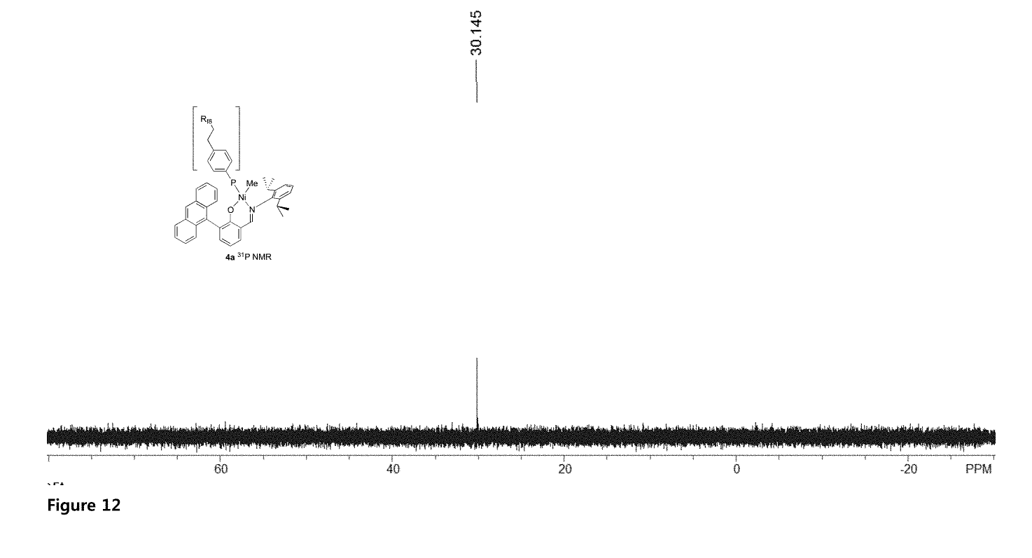

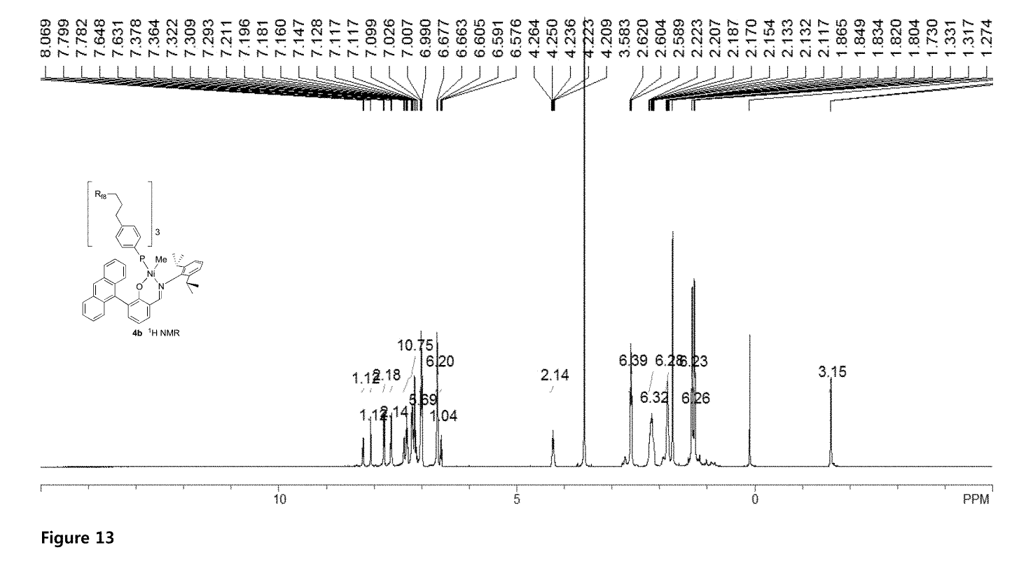

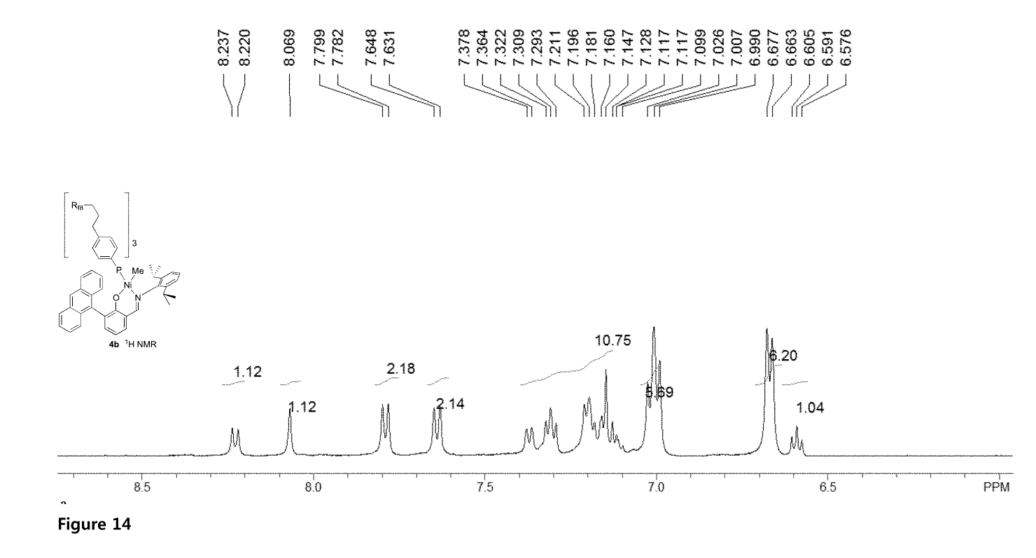

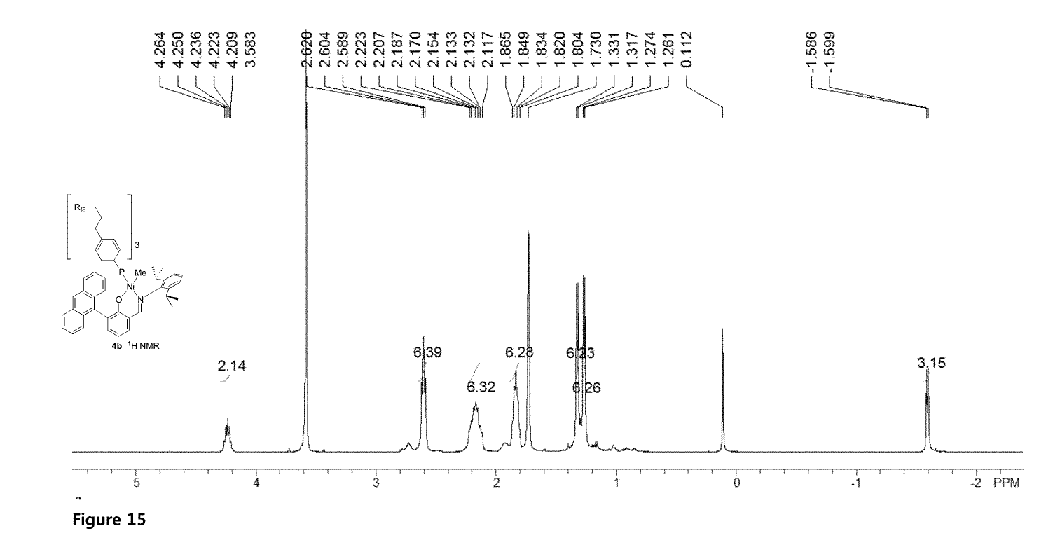

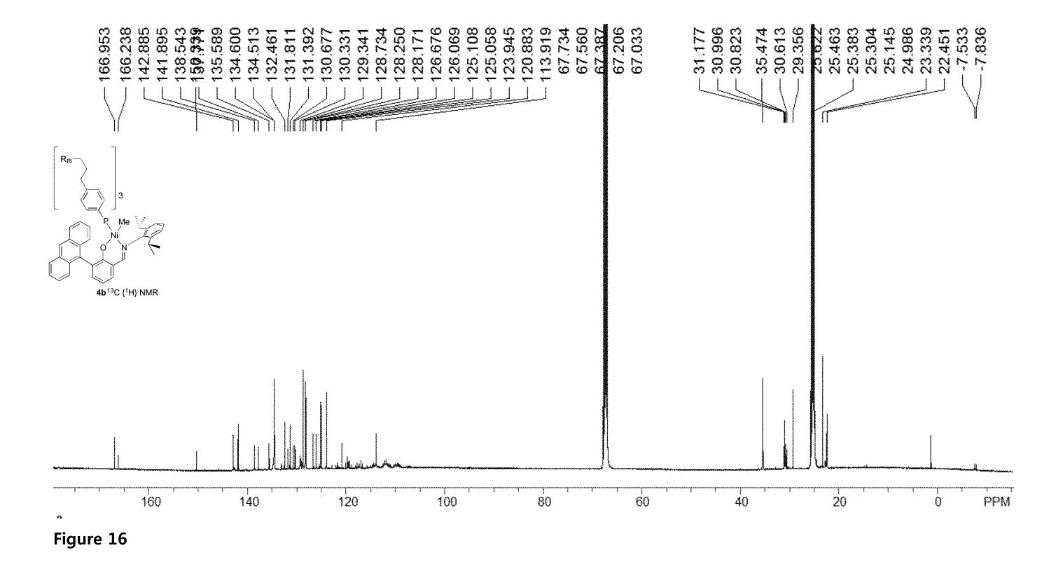

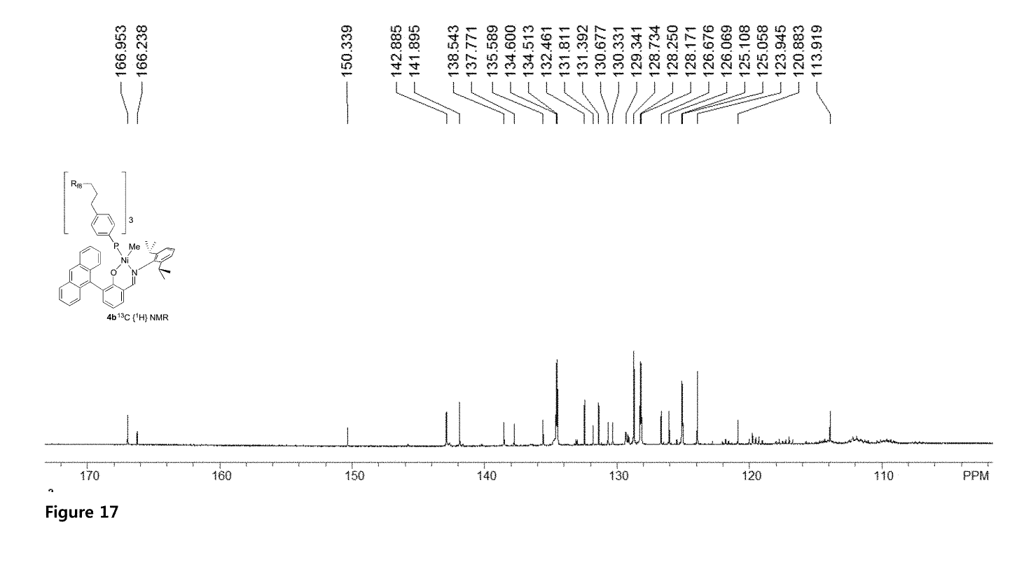

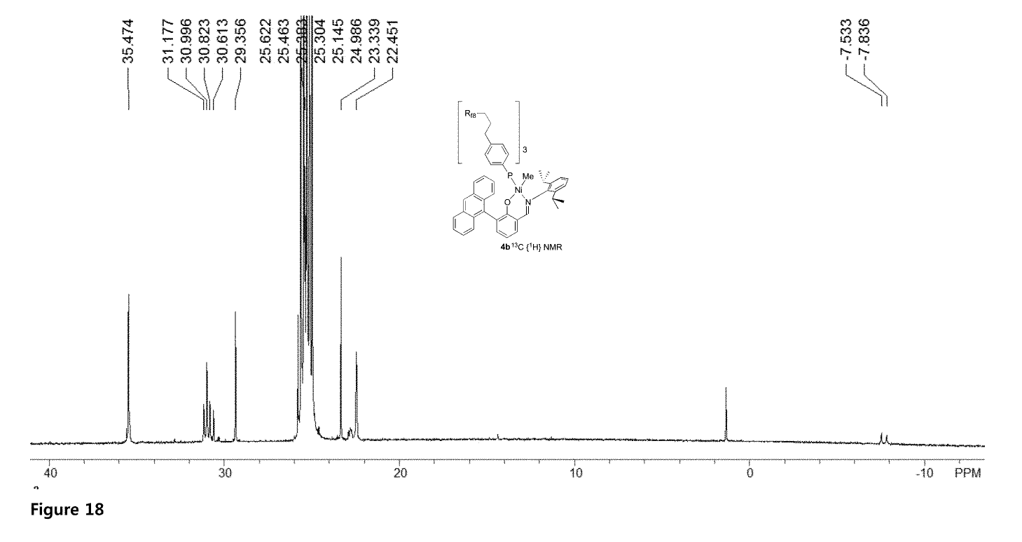

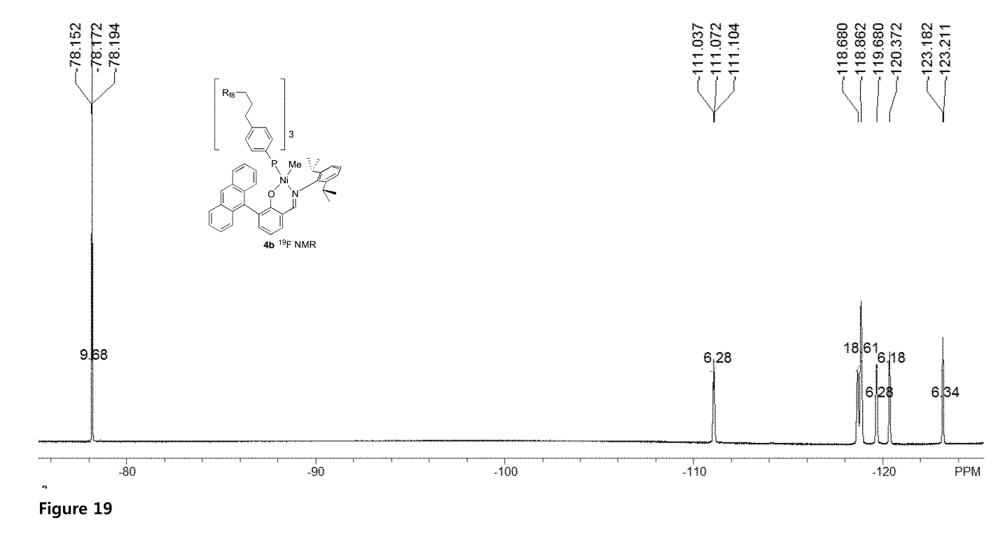

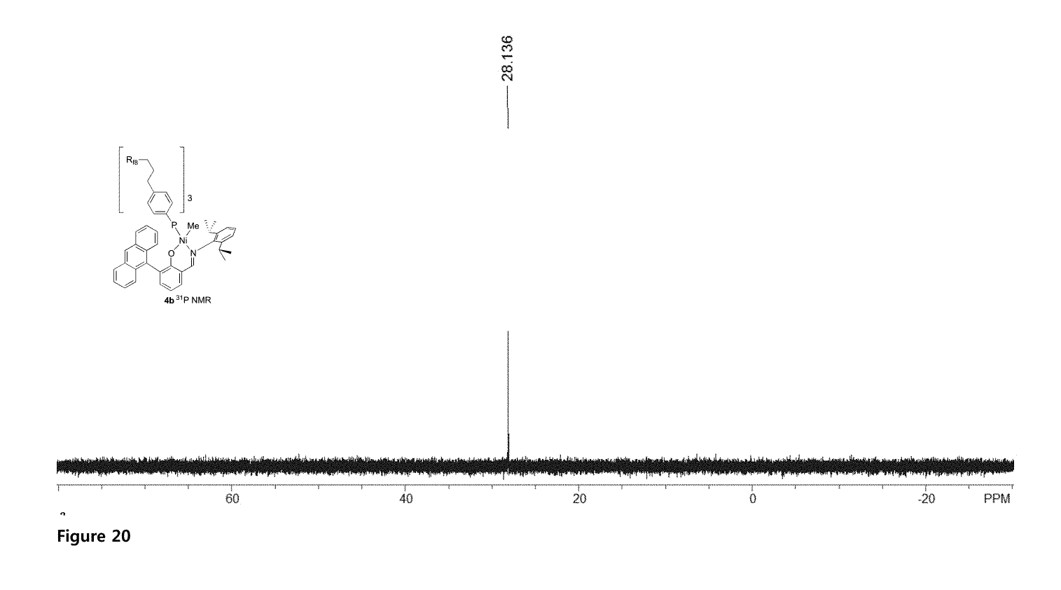

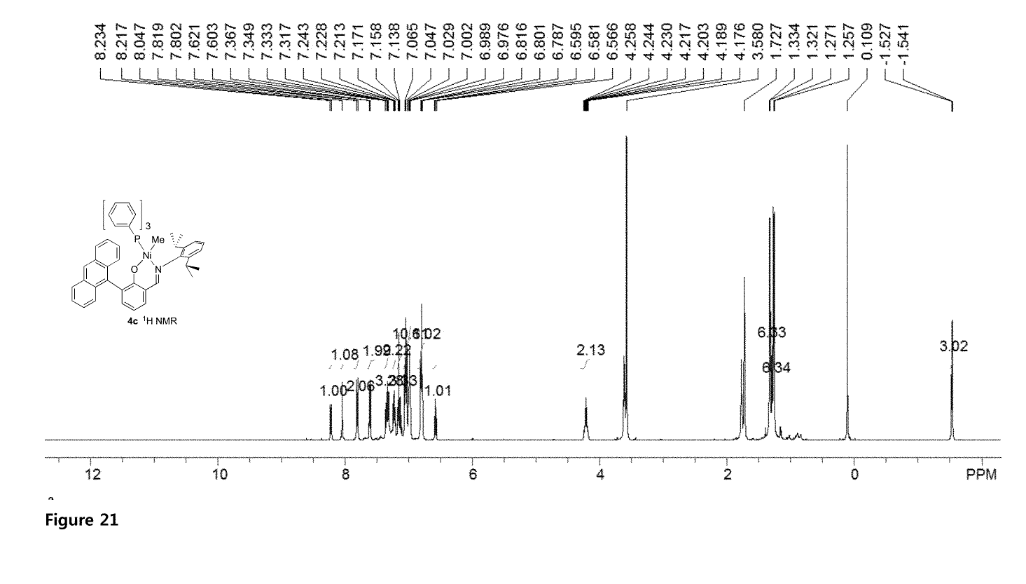

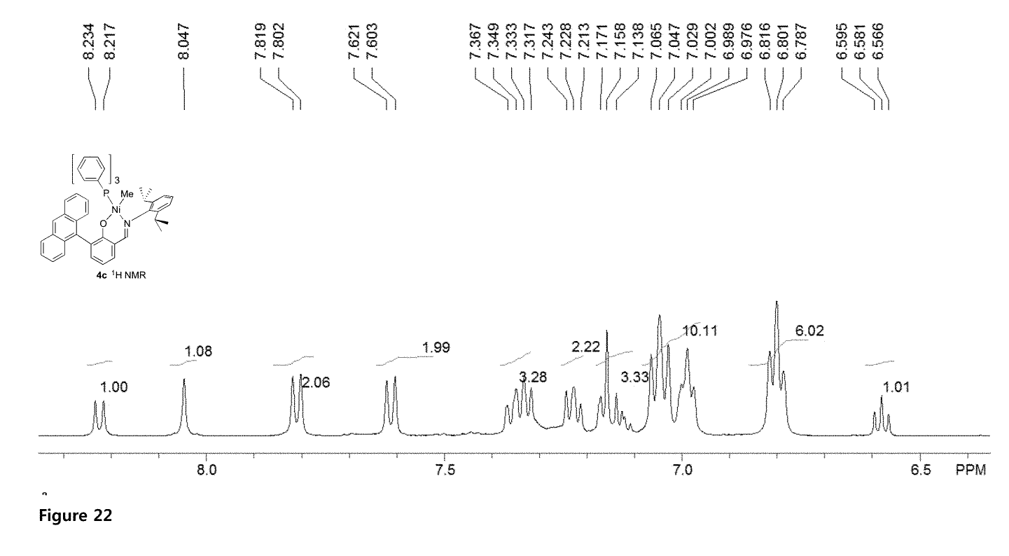

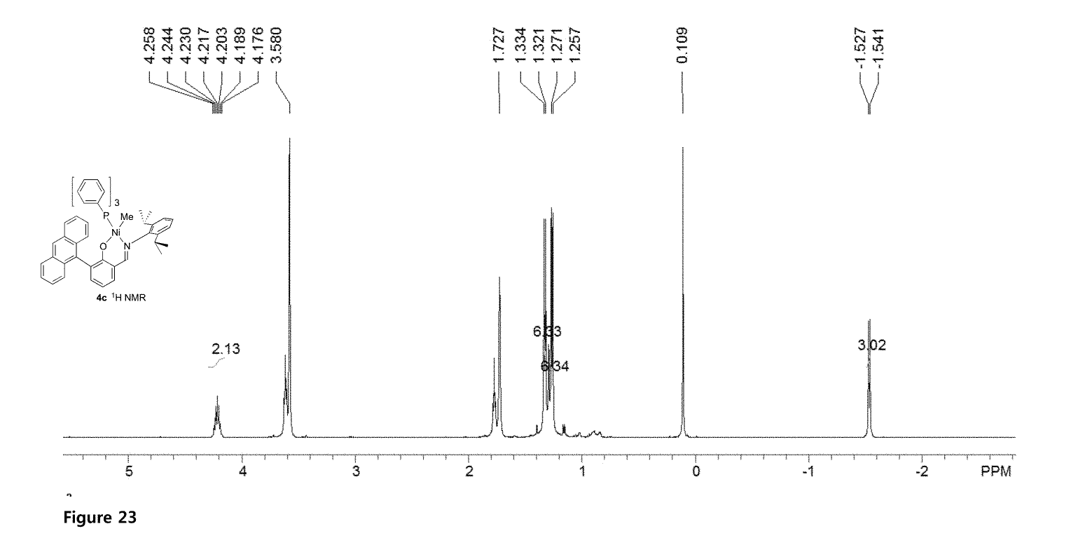

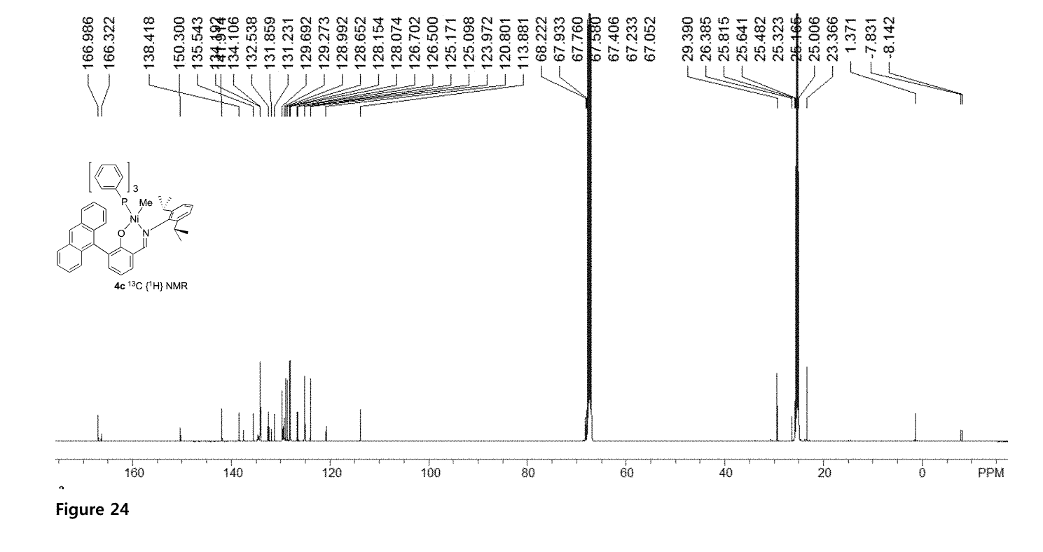

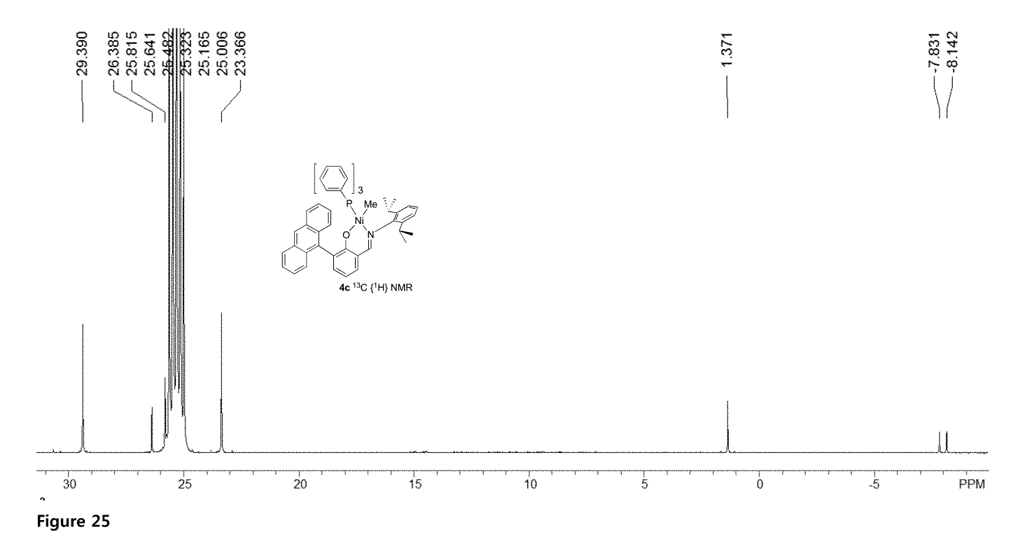

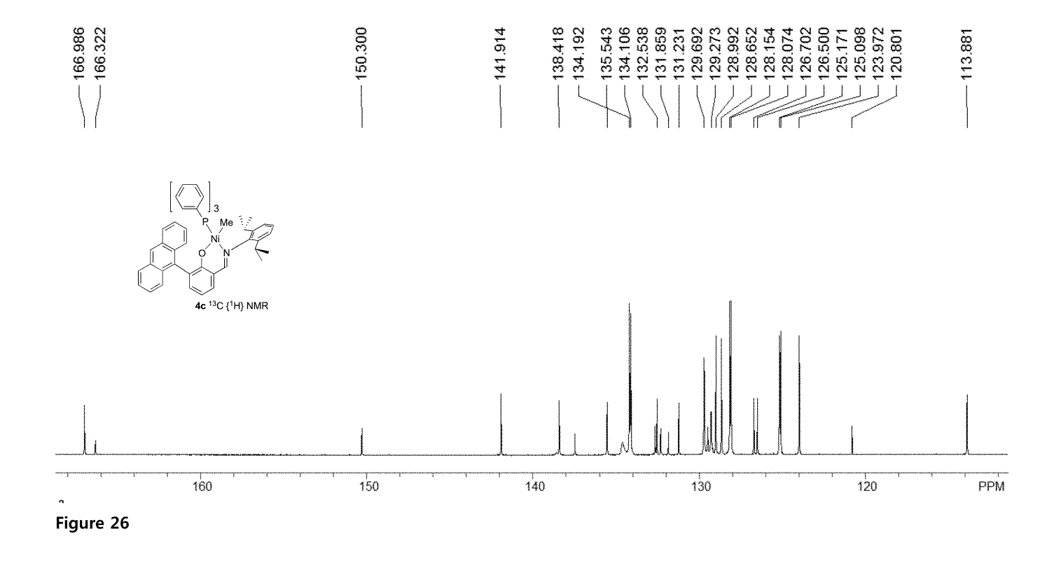

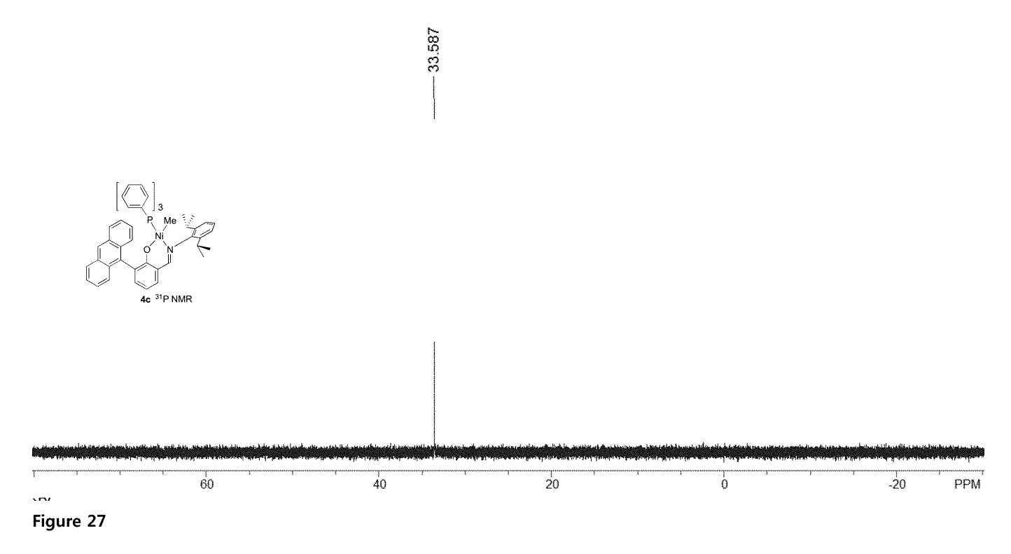

The polymerisations in toluene and toluene/PFMC in FIG. 1A were repeated under 42 psig of ethylene (ca. 4 atm). As shown in FIG. 4 (SI), both were slower, consistent with an enhanced competitiveness of the k₋₁ vs. k₂ step, but the acceleration under biphasic conditions was more pronounced (ca. 3.5- vs. 2.5-fold).

Another experiment was the “non-fluorous control”, in which a catalyst with a non fluorous ligand is analogously evaluated under monophasic and biphasic conditions. As shown in FIG. 2A, 4c gave nearly identical rates in toluene (10 mL, ♦) and toluene/PFMC mixtures (10 mL/5 mL, ▪), consistent with the inability of PPh₃ to partition into the fluorous phase. This also represents the slowest of all catalysts examined in this study.

It was next sought to compare the activities of the new fluorous catalysts with those of established systems. Accordingly, FIG. 2B superimposes the data obtained with catalyst 2 (Scheme 1) under monophasic conditions (toluene, 10 mL, ●) with that for 4a under monophasic (♦) and toluene/PFMC biphasic (▪) conditions in FIG. 1A. In both cases, the fluorous catalyst is more reactive, and the same trend is apparent with 4b. Grubbs has previously shown that 2 exhibits an activity comparable to those of “classical” metallocenes, such as [Cp₂ZrMe]⁺[B(C₆F₅)₄]⁻,^{1a} thus providing an impressive lower bound for 4a,b.

Table 1 summarizes the TOF values after 30 and 60 min for all of the preceding polymerisations. TOF values based upon isolated polyethylene and total reaction times—a common literature format^{1,2,5} but a less direct measure than ethylene uptake—are provided in the footnotes. These data place 4a,b in the top tier of single component nickel(II) ethylene polymerisation catalysts. Note that due to the curvature in the ethylene uptake when 4a is used in toluene/FC-75 (FIG. 1A), this TOF is a stronger function of time (entry 3, Table 1). The physical characteristics of the polyethylene obtained with 4a,b are only modestly affected by fluorous cosolvents. They fall within previously observed ranges for high density polyethylene. The dispersities (M_{w}/Mₙ; 2.42-3.56) and branch content (4-5/1000 carbon atoms) are low, and comparable to those found earlier using 2.^{1a} The melting temperatures (Tₘ) and crystallinities fall into narrow ranges (130-131° C.; 49-57%) that have abundant precedent.

TABLE 1
Polymerisation and Polyethylene (PE) Data.^{a}

| | | | TOF | TOF | M_{w} | | | Crystal- | Tₘ |
|---|---|---|---|---|---|---|---|---|---|
| | | | (10⁻⁵ g PE/ | (10⁻⁵ g PE/ | (10⁻³ g/ | M_{w}/ | Branches/ | linity | (° C., |
| entry | Cat. | solvent system | mol Ni · h)^{b,c} | mol Ni · h)^{b,d} | mol) | Mₙ | 1000 C^{e} | (%)^{f} | DSC) |
| 1 | 4a | toluene | 1.89 | 1.91 | 234 | 2.4 | 4 | 57 | 130 |
| 2 | 4a | toluene/PFMC | 3.63 | 3.37 | 271 | 2.6 | 4 | 52 | 130 |
| 3 | 4a | toluene/FC-75 | 2.26 | 1.69 | 259 | 2.9 | 4 | 57 | 131 |
| 4 | 4b | toluene | 2.60 | 2.61 | 254 | 3.6 | 4 | 49 | 131 |
| 5 | 4b | toluene/PFMC | 3.59 | 3.61 | 250 | 2.7 | 5 | 57 | 130 |
| 6 | 4c | toluene | 0.37 | 0.40 | 160 | 2.8 | 4 | 55 | 132 |
| 7 | 4c | toluene/PFMC | 0.34 | 0.33 | 151 | 3.0 | 4 | 63 | 131 |
| 8 | 2 | toluene | 0.88 | 0.80 | 180 | 2.7 | 5 | 62 | 129 |

^{a}Reaction conditions: ~0.010 g catalyst, room temperature, 100 psig ethylene, 10.0 mL toluene with/without 5.0 mL fluorous solvent;
^{b}TOF values are often expressed in terms of the polyethylene isolated at the end of the reaction. Since the ethylene uptake rates available in this study provide direct TOF measurements, data derived from isolated polyethylene are not analyzed, but would be as follows (10⁻⁵ g PE/mol Ni · h, entries 1-8): 1.45, 3.02, 1.09, 1.33, 2.06, 0.64, 0.54, 1.02.
^{c}These TOF values are obtained after 30 min.
^{d}These TOF values are obtained after 60 min. The principal difference involves entry 3, the only polymerisation to slow during the reaction.
^{e}Assayed by ¹³C{¹H} NMR as described in reference 4c;
^{f}Calculated from the DSC value for ΔHₘ based upon 293 J/g for 100% crystallinity as described in reference 4c.

Some conceptually related results were observed by the Mecking laboratory.^{4b} This group has prepared analogs of IV (Scheme 1) with water soluble phosphine ligands in place of pyridine. Such catalysts would be attractive candidates for phase transfer activation under aqueous/organic liquid/liquid biphasic conditions. However, Mecking has reported that polymerisation rates in water can be much faster than those in toluene, presumably because the ligand free, active nickel catalyst becomes entrained in a lipophilic polymer phase, inhibiting reassociation of the hydrophilic ligand. This could be viewed as a variation on liquid/solid phase transfer activation,⁸ in which the solid phase is not introduced at the outset but rather forms during the reaction. Finally, there have been previous reports of fluorous nickel(11) catalysts for α-olefin oligomerization, but these were concerned with catalyst immobilization or recovery, and activators were required to obtain significant rates.¹⁴

### SUPPORTING INFORMATION

### Experimental Section

General (Catalyst Syntheses).

All reactions were conducted under N₂ unless noted. Toluene, tetrahydrofuran, and acetonitrile were purified using a Glass Contour Solvent System. Perfluoro(methylcyclohexane) (PFMC; ABCR), perfluoro(2-butyltetrahydrofuran) (FC-75; Alfa Aesar), PPh₃ (Aldrich), OPPh₃ (Alfa Aesar), P(4-C₆H₄(CH₂)₂R_{f8})₃ (3a; Fluorous Technologies), HCl (Macron), methanol (VWR), and all deuterated solvents (Cambridge) were used as received. The P(4-C₆H₄(CH₂)₃R_{f8}) (3b),^{s1} [1,2,3-C₆H₃(9-anthracenyl)O(CH═N(2,6-C₆H₄(iPr)₂)]Ni(Me)(NCMe) (1),^{s2} and [1,2,3-C₆H₃(9-anthracenyl)O(CH═N(2,6-C₆H₄(iPr)₂)]Ni(Ph)(PPh₃) (2),^{s3} were prepared by literature procedures.

NMR spectra were recorded on 500 MHz spectrometers at ambient probe temperatures. Samples were referenced as follows (δ, ppm): ¹H, residual internal THF-d₇ (1.73, 3.58); ¹³C, internal THF-d₈ (25.5, 67.7) or CDCl₂CDCl₂ (44.6); ³¹P, external H₃PO₄ (0.00); ¹⁹F, external tri-fluoromethylbenzene (−63.3). Microanalyses were conducted by Atlantic Microlab.

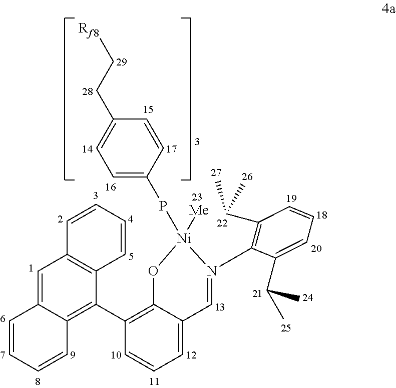

### [1,2,3-C₆H₃(9-anthracenyl)O(CH═N(2,6-C₆H₄(iPr₂)]Ni(Me)[P(4-C₆H₄(CH₂)₂R_{f8})₃] (4a)

A Schlenk tube was charged with 1 (0.027 g, 0.047 mmol), 3a (0.075 g, 0.047 mmol), and THF (2.0 mL) with stirring. After 30 min, the solvent was removed by oil pump vacuum to give 4a an orange solid (0.055 g, 0.026 mmol, 55%)).^{s4} Anal. Calcd. for C₈₂H₅₇F₅₁NNiOP (2129.27): C, 46.22; H, 2.70; N, 0.66. found: C, 45.08; H, 2.69; N, 0.77.^{s5}

NMR (δ/ppm, THF-d₈): ¹H (500 MHz)^{s6,s7} −1.58 (d, J_{PH}=7.0 Hz, 3H, 23-H), 1.26 (d, J_{HH}=7.0 Hz, 6H, iPr), 1.34 (d, J_{HH}=7.0 Hz, 6H, iPr), 2.34-2.44 (m, 6H, 29-H), 2.80 (t, J_{HH}=8.0 Hz 6H, 28-H), 4.22 (sep, J_{HH}=7.0 Hz, 2H, 21- and 22-H), 6.59 (t, J_{HH}=7.5 Hz, 1H, 11-H), 6.72 (d, J_{HH}=7.5 Hz, 6H, 14-H and 15-H), 6.99-7.33 (m, 15H, 3-, 4-, 7-, 8-, 10-, 12-, 16-, 17-, 18-, 19-, 20-H), 7.65 (d, J_{HH}=8.5 Hz, 2H, 9-, 5-H, or 6-, 2-H), 7.81 (d, J_{HH}=8.5 Hz, 2H, 9-, 5-H, or 6-, 2-H), 8.11 (s, 1H, 1-H), 8.23 (d, J_{PH}=8.5 Hz, 1H, 13-H); ¹³C{H} (125 MHz) −7.46 (d, J_{CP}=37.8 Hz, CH₃), 22.9, 23.3, 26.7, 29.4, 32.6 (t, J_{CP}=21.8 Hz), 114.0, 120.8, 123.9, 125.1 (d, J_{CP}=10.8 Hz), 126.0, 126.7, 128.2 (d, J_{CP}=9.8 Hz), 128.8 (d, J_{CP}=6.2 Hz), 129.3, 130.7, 131.1, 131.4, 131.6, 132.5, 134.6 (d, J_{CP}=10.0 Hz), 135.6, 137.8, 138.7, 141.1, 141.8, 150.2, 166.1, 167.0; ³¹P{H} (202.2 MHz) 30.1 (s); ¹⁹F{¹H} (470.1 MHz) −79.9 (t, J_{FF}=10.3 Hz, 9F, CF₃), −113.3 (m, 6F, CF₂), −120.3 to −120.7 (m, 18F, CF₂), −121.4 (6F, CF₂), −124.9 (6F, CF₂).

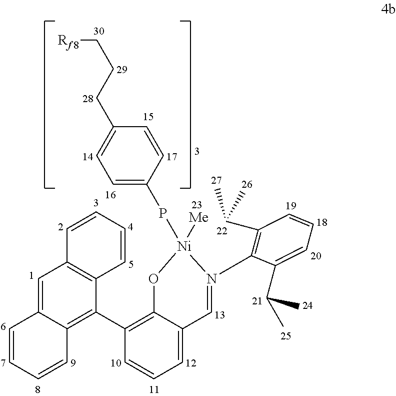

### [1,2,3-C₆H₃(9-anthracenyl)O(CH═N(2,6-C₆H₄(iPr₂)]Ni(Me)[P(4-C₆H₄(CH₂)₃R_{f8})₃] (4b)

A Schlenk tube was charged with 1 (0.057 g, 0.10 mmol), 3b (0.164 g, 0.10 mmol), and THF (4.0 mL) with stirring. After 30 min, the solvent was removed by oil pump vacuum to give 4b as an orange solid (0.145 g, 0.067 mmol, 68%).^{s4} Anal. Calcd. for C₈₅H₆₃F₅₁NNiOP (2171.32): C, 46.98; H, 2.92; N, 0.64. found: C, 45.55; H, 2.81; N, 0.63.^{s5}

NMR (δ/ppm, THF-d₈): ¹H (500 MHz)^{s6,s7} −1.59 (d, J_{PH}=6.5 Hz, 3H, 23-H), 1.26 (d, J_{HH}=7.0 Hz, 6H, iPr), 1.32 (d, J_{HH}=7.0 Hz, 6H, iPr), 1.80-1.86 (m, 6H, 29- or 30-H), 2.11-2.22 (m, 6H, 29- or 30-H), 2.60 (t, J_{HH}=8.0 Hz, 6H, 28-H), 4.23 (sep, J_{HH}=7.0 Hz, 2H, 21- and 22-H), 6.59 (t, J_{HH}=7.5 Hz, 1H, 11-H), 6.66 (d, J_{HH}=7.0 Hz, 6H, 14- and 15-H), 6.99-7.37 (m, 15H, 3-, 4-, 7-, 8-, 10-, 12-, 16-, 17-, 18-, 19-, 20-H), 7.63 (d, J_{HH}=8.5 Hz, 2H, 9-, 5-H or 6-, 2-H), 7.78 (d, J_{HH}=8.5 Hz, 2H, 9-, 5-H, or 6-, 2-H), 8.06 (s, 1H, 1-H), 8.22 (d, J_{PH}=8.5 Hz, 1H, 13-H); ¹³C{¹H} (125 MHz) −7.68 (d, J_{CP}=37.8 Hz), 22.4, 23.3, 26.7, 29.4, 30.6, 30.9 (t, J_{CP}=21.6 Hz), 35.4, 113.9, 120.8, 123.9, 125.1 (d, J_{CP}=6.2 Hz), 126.0, 126.7, 128.2 (d, J_{CP}=10.0 Hz), 128.7, 129.3, 130.3, 130.7, 131.3, 131.8, 132.4, 134.5 (d, J_{CP}=10.8 Hz), 135.6, 137.8, 138.5, 141.8, 142.8, 150.3, 166.2, 166.9; ³¹P{H} (202.2 MHz) 28.1 (s); ¹⁹F{¹H} (470.1 M) −78.1 (t, J_{FF}=10.3 Hz, 9F, CF₃), −111.0 (m, 6F, CF₂), −118.6-−118.8 (m, 18F, CF₂), −120.3 (6F, CF₂), −123.1 (6F, CF₂).

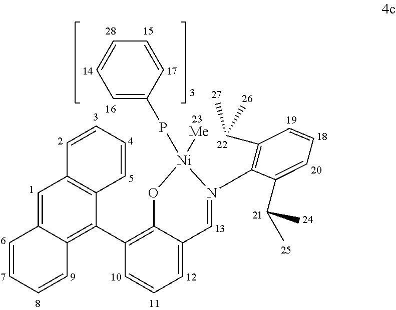

### [1,2,3-C₆H₃(9-anthracenyl)O(CH═N(2,6-C₆H₄(iPr₂)]Ni(Me)(PPh₃) (4c)

A Schlenk tube was charged with 1 (0.028 g, 0.050 mmol), PPh₃ (0.0130 g, 0.050 mmol), and THF (2.0 mL) with stirring. After 30 min, the solvent was removed by oil pump vacuum to give 4c as an orange solid (0.0180 g, 0.023 mmol, 46%).^{s4} Anal. Calcd. for C₅₂H₄₈NNiOP (791.28): C, 78.80; H, 6.10; N, 1.77. found: C, 78.34; H, 6.62; N, 1.50.^{s5}

NMR (δ/ppm, THF-d₈): ¹H (500 MHz)^{s6,s7} −1.53 (d, J_{PH}=7.0 Hz, 3H, 23-H), 1.26 (d, J_{HH}=6.5 Hz, 6H, iPr), 1.33 (d, J_{HH}=6.5 Hz, 6H, iPr), 4.21 (sep, J_{HH}=6.5 Hz, 2H, 21- and 22-H), 6.58 (t, J_{HH}=7.5 Hz, 1H, 11-H), 6.80 (t, J_{HH}=7.0 Hz, 6H, 14- and 15-H), 6.97-7.37 (m, 18H, 3-, 4-, 7-, 8-, 10-, 12-, 16-, 17-, 18-, 19-, 20-, 28-H), 7.61 (d, J_{HH}=8.5 Hz, 2H, 9-, 5-H or 6-, 2-H), 7.81 (d, J_{HH}=8.0 Hz, 2H, 9-, 5-H or 6-, 2-H), 8.05 (s, 1H, 1-H), 8.23 (d, J_{PH}=8.0 Hz, 1H, 13-H); ¹³C{¹H} (125 MHz) −7.83 (d, J_{CP}=38.8 Hz), 23.3, 26.3, 29.3, 113.8, 120.8, 123.9, 125.1 (d, J_{CP}=9.1 Hz), 126.6 (d, J_{CP}=25.2 Hz), 128.1 (d, J_{CP}=10.0 Hz), 128.6, 128.9, 129.2, 129.6, 131.2, 131.8, 132.2, 132.5, 132.6, 134.1 (d, J_{CP}=10.7 Hz), 135.5, 137.4, 138.4, 141.9, 150.3, 166.3, 166.9; ³¹P{¹H} (202 MHz) 33.5.

Partition Coefficients.

The following is representative of experiments conducted with 3a and 4a,b. A 10 mL vial was charged with 4a (0.0233 g, 0.0109 mmol), toluene (2.00 mL) and PFMC (2.00 mL), capped, and vigorously shaken. After 1 h (24° C.), aliquots were removed from the PFMC (1.00 mL) and toluene (1.00 mL) phases. The solvents were evaporated and the residues dried by oil pump vacuum (3 h). A solution of OPPh₃ (0.0098 g, 0.035 mmol) in C₆D₆ (1.000 mL) was prepared. Each residue was taken up in C₆D₆ and an aliquot (0.400 mL) of the OPPh₃ solution was added (0.0039 g, 0.014 mmol). The relative peak integrations gave the value in the text (no signal was detected in the PFMC phase).

General (Polymerisations).

The polymerisations were conducted in the apparatus depicted in FIG. 3. Ethylene gas was purchased from Matheson. The tank was connected via a T shaped stainless steel tubing system to a vacuum line and Sierra Model M100L gas flow meter (factory calibrated for 2-100 standard cm³/min with a measurement error of less than 1%; typical readings during polymerisations were 5-20 cm³/min). The flow meter was in turn connected to a Fischer-Porter bottle, in which the polymerisations were conducted.

Reactions in FIG. 1A.

A. (♦) In an argon glove box, a Fisher-Porter bottle was charged with 4a (0.0114 g, 5.35 μmol) and toluene (10.0 mL) and connected to the gas flow meter using stainless steel tubing. The lower portion was placed in a water bath to help modulate the temperature. Ethylene was introduced (100 psig, or 8 atm), and the uptake required to maintain the initial pressure was monitored (1 data point/min). After 60 min, the polyethylene slurry was poured into methanol/conc. HCl (10:1 v/v). The white solid was isolated by filtration and dried by oil pump vacuum. After 12, the polyethylene sample (0.776 g) was analyzed to give the data in Table 1. B. (▪) Procedure A was repeated using 4a (0.0131 g, 6.15 μmol), toluene (10.0 mL) and PFMC (5.0 mL). Data for the polyethylene sample (1.860 g) are given in Table 1. C. (▴) Procedure B was repeated using 4a (0.0120 g, 5.64 μmol), toluene (10.0 mL), and FC-75 (5.0 mL). Data for the polyethylene sample (0.616 g) are given in Table 1.

Reactions in FIG. 1B.

A. (♦) Procedure A of FIG. 1 was repeated but using 4b (0.0088 g, 4.05 μmol) and toluene (10.0 mL). Data for the polyethylene sample (0.540 g) are given in Table 1. B. (▪) Procedure A was repeated but using 4b (0.0093 g, 4.28 μmol), toluene (10.0 mL) and PFMC (5.0 mL). Data for the polyethylene sample (0.883 g) are given in Table 1.

Reactions in FIG. 2A.

A. (♦) Procedure A of FIG. 1 was repeated but using 4c (0.0086 g, 10.9 μmol) and toluene (10.0 mL). Data for the polyethylene sample (0.693 g) are given in Table 1. B. (▪) Procedure A was repeated but using 4c (0.0092 g, 11.6 μmol), toluene (10.0 mL) and PFMC (5.0 mL). Data for the polyethylene sample (0.625 g) are given in Table 1.

Reactions in FIG. 2B.

A. (●) Procedure A of FIG. 1 was repeated but using 2 (0.0079 g, 9.2 μmol) and toluene (10.0 mL). Data for the polyethylene sample (0.974 g) are given in Table 1. B. (♦) This experiment is identical with A in FIG. 1. C. (▪) This experiment is identical with B in FIG. 1.

Reactions in FIG. 4.

A. (♦) Procedure A of FIG. 1 was repeated but using 4a (0.0155 g, 7.3 μmol), toluene (10.0 mL), and 42 psig (ca. 4 atm) of ethylene. After workup, 0.261 g polyethylene was isolated. B. (▪) Procedure B of FIG. 1 was repeated but using 4a (0.0144 g, 6.8 μmol), toluene (10.0 mL), PFMC (5.0 mL) and 42 psig of ethylene (ca. 4 atm). After workup, 0.859 g polyethylene was isolated.

Ethylene Solubilities.

In a published protocol,^{s8} a Fischer-Porter bottle was charged with 10.0 mL of solvent under an argon atmosphere and weighed. Then the ethylene pressure was increased to 15 psig (2 atm). After equilibration (20-30 min), the bottle was weighed again. This procedure was repeated (3, 4, 5, 6, 7, 8 atm). To calculate the amount of dissolved ethylene, an estimate of the ethylene in the headspace was required. Towards this end, the solvent was replaced by an equal volume of fine metal beads, and the procedure was repeated. The difference in the mass of ethylene taken up in the two experiments was assumed to be that dissolved in the liquid phase in the first experiment.^{s8}

Polyethylene Branch Content.^{s9} The ¹³C{¹H} NMR spectra of all polyethylene samples were recorded at 120° C. in CDCl₂CDCl₂ containing 0.5 weight % Cr(acac)₃. The signal at 35.9 ppm was integrated vs. that at 28.3 ppm under inverse gated decoupled conditions (acquisition time 1.2 s, relaxation delay 1 s).

In summary, the present inventors have extended the concept of phase transfer activation to a new class of metal catalysts, nickel salicylaldiminato complexes with fluorous phosphine ligands. These rank with the most active single component ethylene polymerisation catalysts under organic monophasic conditions, and become significantly more reactive under fluorous/organic liquid/liquid biphasic conditions. This concept is applicable to other polymerisation catalysts, as set out in the claims.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member can be referred to and claimed individually or in any combination with other members of the group or other elements found herein. It is anticipated that one or more members of a group can be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Specific embodiments disclosed herein may be further limited in the claims using consisting of or and consisting essentially of language. When used in the claims, whether as filed or added per amendment, the transition term “consisting of excludes any element, step, or ingredient not specified in the claims. The transition term “consisting essentially of” limits the scope of a claim to the specified materials or steps and those that do not materially affect the basic and novel characteristic(s). Embodiments of the disclosure so claimed are inherently or expressly described and enabled herein.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

### REFERENCES

For the avoidance of doubt, protection may be sought for the features disclosed in any one or more of the referenced documents in combination with this disclosure.

Each of the following references is incorporated herein by reference in its entirety:
1) (a) Younkin, T. R.; Connor, E. F.; Henderson, J. I.; Freidrich, S. K.; Grubbs, R. H.; Bansleben, D. A. Science 2000, 287, 460-462. (b) Connor, E. F.; Younkin, T. R.; Henderson, J. I.; Waltman, A. W.; Grubbs, R. H. Chem. Commun. 2003, 2272-2273. (c) Connor, E. F.; Younkin, T. R.; Henderson, J. I.; Hwang, S.; Grubbs, R. H.; Roberts, W. P.; Litzau, J. J. J. Polym. Sci. Part A: Polym. Chem. 2002, 40, 2842-2854.
(2) (a) Hicks, F. A.; Jenkins, J. C.; Brookhart, M. Organometallics 2003, 22, 3533-3545. (d) Jenkins, J. C.; Brookhart, M. J. Am. Chem. Soc. 2004, 126, 5827-5842. (c) Chen, Z.; Mesgar, M.; White, P. S.; Daugulis, O.; Brookhart, M. ACS Catalysis 2015, 5, 631-636.
(3) (a) Starzewski, K. A. O.; Witte, J. Angew. Chem. Int. Ed. Engl. 1987, 26, 63-64; Angew. Chem. 1987, 99, 76-77. (b) Johnson, L. K.; Bennett, A. M.; Ittel, S. D.; Wang, L.; Parthasarathy, A.; Hauptman, E.; Simpson, R. D.; Feldman, J.; Coughlin, E. B. WO 98/30609, 1998; Chem. Abstr. 1998, 129, 149362.
(4) (a) Zuideveld, M. A.; Wehrmann, P.; Röhr, C.; Mecking, S. Angew. Chem., Int. Ed. Engl. 2004, 43, 869-873; Angew. Chem. 2004, 116, 887-891. (b) Göttker-Schnetmann, I.; Korthals, B.; Mecking, S. J. Am. Chem. Soc. 2006, 128, 7708-7709. (c) Göttker-Schnetmann, I.; Wehrmann, P.; Röhr, C.; Mecking, S. Organometallics, 2007, 26, 2348-2362. (d) Osichow, A.; Rabe, C.; Vogtt, K.; Narayanan, T.; Harnau, L.; Drechsler, M.; Ballauff, M.; Mecking, S. J. Am. Chem. Soc. 2013, 135, 11645-11650.
(5) (a) Song, D.-P.; Wu, J.-Q.; Ye, W.-P.; Mu, H.-L.; Li, Y. S. Organometallics 2010, 29, 2306-2314. (b) Mu, H.-L.; Ye, W.-P.; Song, D.-P.; Li, Y.-S. Organometallics 2010, 29, 6282-6290. (c) Song, D.-P.; Shi, X.-C.; Wang, Y.-X.; Yang, J.-X.; Li, Y.-S. Organometallics 2012, 31, 966-975.
(6) (a) Correa da Costa, R.; Gladysz, J. A. Chem. Commun. 2006, 2619-2621. (b) Correa da Costa, R.; Gladysz, J. A. Adv. Synth. Catal. 2007, 349, 243-254. (c) Tuba, R.; Correa da Costa, R.; Bazzi, H. S.; Gladysz, J. A. ACS Catalysis 2012, 2, 155-162.
(7) Xi, Z.; Bazzi, H. S.; Gladysz, J. A. Org. Lett. 2011, 13, 6188-6191.
(8) Xi, Z.; Bazzi, H. S.; Gladysz, J. Catal. Sci. Technol. 2014, 4, 4178-4182.
(9) (a) Handbook of Fluorous Chemistry, Gladysz, J. A.; Curran, D. P.; Horváth, I. T. Eds.; Wiley/VCH, Weinheim, 2004. (b) Fluorous Chemistry, Horváth, I. T. Ed. Top. Curr. Chem. 2012, 308; Springer, Heidelberg.
(10) (a) Sobs, T.; Bennett, B. L.; Rutherford, D.; Barthel-Rosa, L. P.; Gladysz, J. A. Organometallics 2001, 20, 3079-3086. (b) Darses, S.; Pucheault, M.; Genêt, J.-P. Eur. J. Org. Chem. 2001, 1121-1128.
(11) For partition coefficients of 3a involving other fluorous solvents and more polar organic solvents (all >99.9:<0.1), see Chu, Q.; Yu, M. S.; Curran, D. P. Tetrahedron 2007, 63, 9890-9895 (Table 6).
(12) Richter, B.; Deelman, B.-J.; van Koten, G. J. Mol. Catal. A. 1999, 145, 317-321 (see footnote 2; taken as concentration ratio of <0.14/25:1 or <0.0056:1).
(13) Gladysz, J. A.; Emnet, C. in Handbook of Fluorous Chemistry, Gladysz, J. A.; Curran, D. P.; Horváth, I. T. Eds.; Wiley/VCH, Weinheim, 2004, Ch. 3.
(14) (a) Keim, W.; Vogt, M.; Wasserscheid, P.; Drießen-Hölscher, B. J. Mol. Catal. A 1999, 139, 171-175. (b) Benvenuti, F.; Carlini, C.; Marchionna, M. Galletti, A. M. R.; Sbrana, G. J. Mol. Catal. A 2002, 178, 9-20.
(15) Gladysz, J. A. in Handbook of Green Chemistry, Anastas, P., Ed.; Volume 1: Homogeneous Catalysis; Crabtree, R. H. Volume Ed.; Wiley/VCH, Weinheim, 2009, Ch. 2.
(s1) Soós, T.; Bennett, B. L.; Rutherford, D.; Barthel-Rosa, L. P.; Gladysz, J. A. Organometallics 2001, 20, 3079-3086.
(s2) Connor, E. F.; Younkin, T. R.; Henderson, J. I.; Waltman, A. W.; Grubbs, R. H. Chem. Commun. 2003, 2272-2273.
(s3) Wang, C.; Friedrich, S.; Younkin, T. R.; Li, R. T.; Grubbs, R. H.; Bansleben, D. A.; Day, M. W. Organometallics 1998, 17, 3149-3151.
(s4) The mass loss is due to incomplete transfer out of the Schlenk tube in the glove box. Yields of reactions conducted on larger scales would be higher.
(s5) Microanalytical data for the catalysts were not within commonly accepted limits, so NMR spectra are provided.
(s6) The ¹H NMR assignments are based upon those established by 2D NMR experiments for related nickel salicylaldiminato complexes.^{s7}
(s7) (a) Göttker-Schnetmann, I.; Wehrmann, P.; Röhr, C.; Mecking, S. Organometallics, 2007, 26, 2348-2362. (b) Osichow, A.; Rabe, C.; Vogtt, K.; Narayanan, T.; Harnau, L.; Drechsler, M.; Ballauff, M.; Mecking, S. J. Am. Chem. Soc. 2013, 135, 11645-11650.
(s8) Mecking, S.; Johnson, L. K.; Wang, L.; Brookhart, M. J. Am. Chem. Soc. 1998, 120, 888-899.
(s9) See the supporting information for reference s7b.

1. A polymerisation catalyst having the structure: 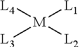
wherein:
M is Ni or Pd,
L₁ is alkyl or aryl,
L₂ and L₃ together form a bidentate ligand, and
L₄ is a fluorous phosphorous donor ligand, a fluorous nitrogen donor ligand, a fluorous sulfur donor ligand or a fluorous oxygen donor ligand.

2. The polymerisation catalyst of claim 1, wherein M is Ni.

3. The polymerisation catalyst of claim 1, wherein the fluorous phosphorous donor ligand, fluorous nitrogen donor ligand, fluorous sulfur donor ligand or fluorous oxygen donor ligand (L₄) includes at least one fluorine atom attached to an aliphatic moiety; optionally, at least, 2, 3, 4, 5, 6, 7, 8, 9, 10, 11, 12, 13, 14, 15, 16, 17, 18, 19, 20 or more fluorine atoms attached to an aliphatic moiety.

4. The polymerisation catalyst of claim 1, wherein L₄ is a fluorous phosphorous donor ligand selected from the group consisting of a fluorinated phosphine ligand (fluorinated PRₓR_{y}R_{z}), a fluorinated phosphite ligand (fluorinated PORₓOR_{y}ORₓ), fluorinated PRₓOR_{y}OR_{z}, fluorinated PRₓR_{y}OR_{z}; wherein Rₓ, R_{y} and R_{z} are the same or different; or fluorinated phosphapyridine.

5. The polymerisation catalyst of claim 1, wherein:
L₄ is a fluorous phosphorous donor ligand having the structure: 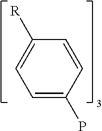
wherein R is (CH₂)ₙ(CF₂)ₘCF₃, or (CH₂)ₙ(CHF)ₘCF₃, and,
n is 0, 1, 2, 3, 4, 5, 6, 7, 8, 9 or 10, and,
m is 0, 1, 2, 3, 4, 5, 6, 7, 8, 9 or 10; or,
wherein L₄ is a fluorous phosphorous donor ligand having the structure: 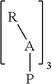
wherein R is (CH₂)ₙ(CF₂)ₘCF₃, or (CH₂)ₙ(CHF)ₘCF₃, and,
n is 0, 1, 2, 3, 4, 5, 6, 7, 8, 9 or 10,
m is 0, 1, 2, 3, 4, 5, 6, 7, 8, 9 or 10; and,
A is aliphatic.

6. The polymerisation catalyst of claim 1, wherein L₄ is a fluorous phosphorous donor ligand having the structure: 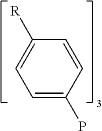
wherein R is (CH₂)₂(CF₂)₇CF₃ or (CH₂)₃(CF₂)₇CF₃.

7. The polymerisation catalyst of claim 1, wherein L₄ is:
a fluorous nitrogen donor ligand selected from the group consisting of a fluorinated amine ligand, a fluorinated nitrile ligand, a fluorinated pyridine ligand, a fluorinated heterocycle with a basic lone pair of electrons, a fluorinated imine, and a fluorinated Schiff base; or,
a fluorous oxygen donor ligand; optionally wherein the fluorous oxygen donor ligand is a fluorinated ether.

8. The polymerisation catalyst of claim 1, wherein L₁ is alkyl and is a straight-chain or branched-chain hydrocarbon having 1, 2, 3, 4, 5, 6, 7, 8, 9, 10, 11, 12, 13, 14, 15, 16, 17, 18, 19 or 20 carbon atoms linked exclusively by single bonds and not having any cyclic structure.

9. The polymerisation catalyst of claim 8, wherein L₁ is alkyl and is selected from the group consisting of methyl, ethyl, n-propyl, isopropyl, n-butyl, isobutyl, sec-butyl, tert-butyl, pentyl, iso-amyl, hexyl, heptyl, octyl, noyl, decyl, undecyl, dodecyl tridecyl, tetradecyl, pentadecyl, hexadecyl, heptadecyl, octadecyl, nonadecyl and eicosyl.

10. The polymerisation catalyst of claim 1 wherein L₁ is methyl (CH₃).

11. The polymerisation catalyst of claim 1, wherein L₁ is aryl and is a substituted or unsubstituted aromatic hydrocarbon with a conjugated cyclic molecular ring structure of 3, 4, 5, 6, 7, 8, 9, 10, 11 or 12 carbon atoms.

12. The polymerisation catalyst of claim 11, wherein L₁ is aryl and is selected from the group consisting of monocyclic, bicyclic and polycyclic.

13. The polymerisation catalyst of claim 12, wherein L₁ includes one to three additional ring structures selected from the group consisting of a cycloalkyl, a cycloalkenyl, a heterocycloalkyl, a heterocycloalkenyl, and a heteroaryl.

14. The polymerisation catalyst of claim 12, wherein L₁ is selected from the group consisting of phenyl (benzenyl), thiophenyl, indolyl, naphthyl, totyl, xylyl, anthracenyl, phenanthryl, azulenyl, biphenyl, naphthalenyl, 1-methylnaphthalenyl, acenaphthenyl, acenaphthylenyl, anthracenyl, fluorenyl, phenalenyl, phenanthrenyl, benzo[a]anthracenyl, benzo[c]phenanthrenyl, chrysenyl, fluoranthenyl, pyrenyl, tetracenyl (naphthacenyl), triphenylenyl, anthanthrenyl, benzopyrenyl, benzo[a]pyrenyl, benzo[e]fluoranthenyl, benzo[ghi]perylenyl, benzo[j]fluoranthenyl, benzo[k]fluoranthenyl, corannulenyl, coronenyl, dicoronylenyl, helicenyl, heptacenyl, hexacenyl, ovalenyl, pentacenyl, picenyl, perylenyl, and tetraphenylenyl.

15. The polymerisation catalyst of claim 12 wherein substituted aryl refers to aryls substituted with 1, 2, 3, 4 or 5 substituents independently selected from the group consisting of H, lower alkyl, aryl, alkenyl, alkynyl, arylalkyl, alkoxy, aryloxy, arylalkoxy, alkoxyalkylaryl, alkylamino, arylamino, NH₂, OH, CN, NO₂, OCF₃, CF₃, Br, Cl, F, 1-amidino, 2-amidino, alkylcarbonyl, morpholino, piperidinyl, dioxanyl, pyranyl, heteroaryl, furanyl, thiophenyl, tetrazolo, thiazole, isothiazolo, imidazolo, thiadiazole, thiadiazole S-oxide, thiadiazole S,S-dioxide, pyrazolo, oxazole, isoxazole, pyridinyl, pyrimidinyl, quinoline, isoquinoline, SR′″, SOR′″, SO₂R′″, CO₂R′″, COR′″, CONR′″R′″, CSNR′″R′″ and SOnNR′″R′″, where n is zero, one or two, wherein R′″ is alkyl or substituted alkyl.

16. The polymerisation catalyst according to claim 1, wherein L₂ and L₃ together form a bidentate ligand, the bidentate ligand selected from the group consisting of, salicylaldiminato, oxalate, ethylenediamine, 2,2′-bipyridine, 1,10-phenanthroline, acetylacetonate and phenanthroline.

17. The polymerisation catalyst according to claim 1, wherein L₂ and L₃ together form a bidentate ligand having the structure: 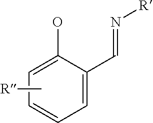
wherein:
R′ is H, 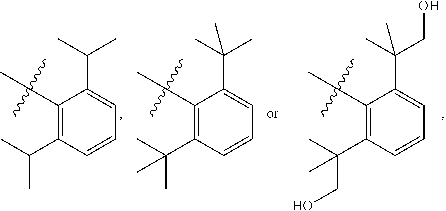
and
R″ is OCH₃, NO₂ or

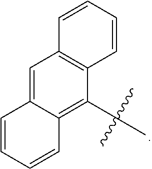 [SMILES: *c1c2ccccc2cc2ccccc12]

18. The polymerisation catalyst according to claim 1, wherein L₂ and L₃ together form a bidentate ligand, the bidentate ligand being a salicylaldiminato ligand.

19. The polymerisation catalyst according to claim 1, wherein L₂ and L₃ together form a bidentate ligand having the structure:

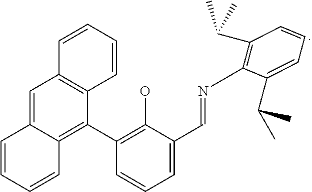

20. The polymerisation catalyst according to claim 1, wherein the polymerisation catalyst has the structure: 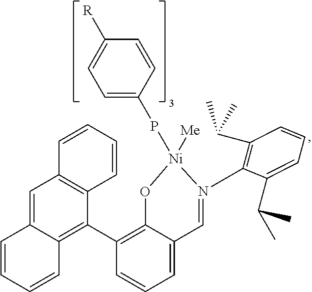
wherein R is (CH₂)₂(CF₂)₇CF₃.

21. The polymerisation catalyst according to claim 1, wherein the polymerisation catalyst has the structure: 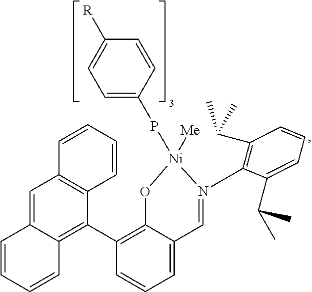
wherein R is (CH₂)₃(CF₂)₇CF₃.

22. A biphasic mixture comprising:
a first solvent and a second solvent, wherein the first solvent and second solvent are immiscible, and
a polymerisation catalyst which dissolves in the first solvent, the polymerisation catalyst including a ligand which reversibly disassociates from the polymerisation catalyst and transfers into the second solvent;
optionally, 25% to 99% by weight of the ligand which reversibly disassociates from the polymerisation catalyst transfers into the second solvent; further optionally, 33% to 99% by weight, 33% to 66% by weight or 65% to 99% by weight of the ligand which reversibly disassociates from the polymerisation catalyst transfers into the second solvent.

23. The biphasic mixture of claim 22, further comprising monomers which dissolve in the first solvent.

24. The biphasic mixture of claim 23, wherein the monomers compete with the ligand for the active catalyst formed when the ligand disassociates from the active catalyst.

25. The biphasic mixture of claim 22, wherein:
the first solvent is an organic solvent and the second solvent is a fluorous solvent.

26. The biphasic mixture of claim 25, wherein the first solvent is an organic solvent selected from the group consisting of: toluene, benzene, aromatic solvents, ethers, diethyl ether, dichloromethane, chloroform, ethyl acetate and acetone.

27. The biphasic mixture of claim 25, wherein the second solvent is a fluorous solvent selected from the group consisting of: perfluoro(methylcyclohexane) (PFMC), perfluoro(2-butyltetrahydrofuran) (FC-75), a fluorocarbon, wherein a fluorocarbon is a hydrocarbon in which all carbon atoms are bonded to fluorine atoms, and a fluorohydrocarbon, wherein a fluorohydrocarbon is a hydrocarbon in which one or more carbon atoms is bonded to a fluorine atom.

28. A biphasic mixture comprising:
a first solvent and a second solvent, wherein the first solvent and second solvent are immiscible, and
the polymerisation catalyst according to claim 1, which dissolves in the first solvent, the polymerisation catalyst including a ligand which reversibly disassociates from the polymerisation catalyst and transfers into the second solvent;
optionally, 25% to 99% by weight of the ligand which reversibly disassociates from the polymerisation catalyst transfers into the second solvent; further optionally, 33% to 99% by weight, 33% to 66% by weight or 65% to 99% by weight of the ligand which reversibly disassociates from the polymerisation catalyst transfers into the second solvent.

29. A biphasic mixture of comprising:
a first solvent and a second solvent, wherein the first solvent and second solvent are immiscible, and
a polymerisation catalyst which dissolves in the first solvent, the polymerisation catalyst including a ligand according to claim 1 which reversibly disassociates from the polymerisation catalyst and transfers into the second solvent;
optionally, 25% to 99% by weight of the ligand which reversibly disassociates from the polymerisation catalyst transfers into the second solvent; further optionally, 33% to 99% by weight, 33% to 66% by weight or 65% to 99% by weight of the ligand which reversibly disassociates from the polymerisation catalyst transfers into the second solvent.

30. The biphasic mixture of claim 22, wherein:
the first solvent is toluene,
the second solvent is PFMC or FC-75,
the polymerisation catalyst has the structure: 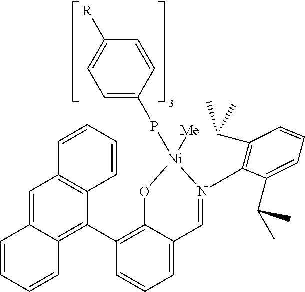
wherein R is (CH₂)₂(CF₂)₇CF₃ or (CH₂)₃(CF₂)₇CF₃,
and the ligand which reversibly disassociates from the polymerisation catalyst and transfers into the second solvent has the structure, 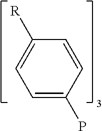
wherein R is (CH₂)₂(CF₂)₇CF₃ or (CH₂)₃(CF₂)₇CF₃, respectively.

31. The biphasic mixture of claim 23, wherein the monomer is ethylene.

32. The biphasic mixture of claim 22, wherein the first solvent is an organic solvent and the second solvent is water;
optionally, wherein the ligand which reversibly disassociates from the polymerisation catalyst and transfers into the second solvent is a water soluble ligand; optionally a phosphine ligand.

33. The biphasic mixture of claim 22, wherein the first solvent is an organic solvent and the second solvent is a solid phase; optionally, the ligand which reversibly disassociates from the polymerisation catalyst and transfers into the second solvent is a fluorous donor ligand.

34. The biphasic mixture of claim 33, wherein the solid phase is a fluorous solid phase.

35. The biphasic mixture of claim 33, wherein the solid phase is selected from the group consisting of:
(a) polytetrafluoroethylene shavings;
(b) high-surface area forms of polytetrafluoroethylene; optionally polytetrafluoroethylene that has been deliberately damaged, etched, or modified by chemical or mechanical means;
(c) non-commercial grades or analogs of polytetrafluoroethylene, which may be in-situ generated, of lower molecular weight, contain structural defects, impurities, or co-monomers that may disrupt the regular structure;
(d) perfluorinated or highly fluorinated polymers;
(e) non-fluorous polymers (polyamides, polyolefins, polyesters) or biomaterials into which fluorous domains have been incorporated by copolymerization, functionalization, grafting, or other techniques;
(f) inorganic oxides such as alumina or silica onto which fluorous domains have been introduced, by absorption or covalent attachment; optionally, fluorous silica gel;
(g) solid polymeric or extended domain materials including binary phases, tertiary phases, single crystals, supramolecular compounds, etc. onto which fluorous domains have been introduced by absorption or covalent attachment; and
(h) analogous non-polymeric materials or oligomers or mixtures thereof that are insoluble under low temperature limit workup conditions and contain fluorous domains.

36. The biphasic mixture of claim 33 wherein the solid phase is selected from the group consisting of:
CF₃(CF₂)₁₀CF₃ (mp 76° C.), CF₃(CF₂)₁₂CF₃ (mp 103° C.), CF₃(CF₂)₁₄CF₃ (mp 125° C.), CF₃(CF₂)₁₈CF₃ (mp 162-169° C.), CF₃(CF₂)₈CF₂H (mp 32° C.) and (F₃C)₃CC(CF₃)₃ (mp 39° C.).

37. The biphasic mixture of claim 32, wherein the organic solvent is selected from the group consisting of: toluene, benzene, aromatic solvents, ethers, diethyl ether, dichloromethane, chloroform, ethyl acetate and acetone.

38. A biphasic mixture of comprising:
a first solvent comprising an organic solvent and a second solvent comprising water, wherein the first solvent and second solvent are immiscible, and
a polymerisation catalyst according to claim 1 which dissolves in the first solvent, the polymerisation catalyst including a ligand which reversibly disassociates from the polymerisation catalyst and transfers into the second solvent, optionally wherein the ligand is a water soluble ligand; and
optionally, 25% to 99% by weight of the ligand which reversibly disassociates from the polymerisation catalyst transfers into the second solvent; further optionally, 33% to 99% by weight, 33% to 66% by weight or 65% to 99% by weight of the ligand which reversibly disassociates from the polymerisation catalyst transfers into the second solvent; and
optionally, a phosphine ligand.

39. A biphasic mixture comprising:
a first solvent comprising an organic solvent and a second solvent comprising water, wherein the first solvent and second solvent are immiscible, and
a polymerisation catalyst which dissolves in the first solvent, the polymerisation catalyst including a ligand which reversibly disassociates from the polymerisation catalyst and transfers into the second solvent, the ligand having the structure according to claim 1, optionally wherein the ligand is a water soluble ligand;
optionally, 25% to 99% by weight of the ligand which reversibly disassociates from the polymerisation catalyst transfers into the second solvent; further optionally, 33% to 99% by weight, 33% to 66% by weight or 65% to 99% by weight of the ligand which reversibly disassociates from the polymerisation catalyst transfers into the second solvent; and
optionally, a phosphine ligand.

40. The biphasic mixture of claim 32, wherein the monomer is ethylene.

41. A method of forming a polymer, the method comprising the steps of:
dissolving a polymerisation catalyst according to claim 1 in a solvent, and
contacting the dissolved polymerisation catalyst with monomers.

42. A method of forming a polymer, the method comprising the steps of:
providing a biphasic mixture according to claim 22, and
contacting the dissolved polymerisation catalyst with monomers.

43. The method of claim 41, further comprising the step of:
contacting the monomers with the dissolved polymerisation catalyst at a pressure above atmospheric pressure; optionally between 6 and 10 atmospheres; optionally at 8 atmospheres plus or minus 10%.

44. The method of claim 41, wherein the monomers comprise of ethylene.

45. A catalyst according to any one of the catalysts of Scheme 2.

46-47. (canceled)
